(19) United States
(12) Patent Application Publication
(10) Pub. No.: US 2024/0413938 A1
(43) Pub. Date: Dec. 12, 2024

(54) UE-SPECIFIC TDD UL/DL CONFIGURATION

(71) Applicant: Lenovo (Singapore) Pte. Ltd., New Tech Park (SG)

(72) Inventors: Hyejung Jung, Northbrook, IL (US); Vijay Nangia, Woodridge, IL (US); Majid Ghanbarinejad, Chicago, IL (US)

(21) Appl. No.: 18/697,299

(22) PCT Filed: Sep. 29, 2022
(86) PCT No.: PCT/IB2022/059309

§ 371 Date: Mar. 29, 2024

Related U.S. Application Data
(60) Provisional application No. 63/250,136, filed on Sep. 29, 2021.

(51) Int. Cl. H04L 5/00; H04L 5/14

(52) U.S. Cl. CPC H04L 5/0023; H04L 5/0048; H04L 5/1469

(57) ABSTRACT

Apparatuses, methods, and systems are disclosed for UE-specific TDD UL/DL configurations for full-duplex operation. One method includes receiving information of a cell-specific TDD UL/DL configuration and receiving information of a plurality of UE-specific TDD UL/DL configurations, where each of the plurality of UE-specific TDD UL/DL configurations is associated with particular spatial information. The method includes performing—based on the plurality of UE-specific TDD UL/DL configurations—a transmission in a first set of symbols of a slot, where at least one symbol of the first set of symbols of the slot overlaps with a downlink symbol indicated by the cell-specific TDD UL/DL configuration, or a reception in a second set of symbols of the slot, where at least one symbol of the second set of symbols of the slot overlaps with an uplink symbol indicated by the cell-specific TDD UL/DL configuration.

### CROSS-REFERENCE TO RELATED APPLICATIONS

This application claims priority to U.S. Provisional Patent Application No. 63/250,136 entitled “MULTIPLE TRP-BASED FULL DUPLEX CELL OPERATION” and filed on 29 Sep. 2021 for Hyejung Jung, Vijay Nangia, and Majid Ghanbarinejad, which application is incorporated herein by reference.

### FIELD

The subject matter disclosed herein relates generally to wireless communications and more particularly relates to full duplex cell operation considering multiple Transmission and Reception Points (“TRPs”).

### BACKGROUND

In communication systems, half-duplex mode refers to a communication mode where devices can only communicate in one direction at a time (i.e., devices switch between transmitting and receiving), whereas full-duplex mode refers to a communication mode where devices can communicate in both directions simultaneously (i.e., devices can both transmit and receive communication signals at the same time).

### BRIEF SUMMARY

Disclosed are procedures related to dedicated Time-Division Duplex (“TDD”) Uplink and Downlink (“UL/DL”) configurations for full-duplex operation. Said procedures may be implemented by apparatus, systems, methods, or computer program products.

One method at a User Equipment (“UE”) includes receiving information of a cell-specific TDD UL/DL configuration and receiving information of a plurality of UE-specific TDD UL/DL configurations, where each of the plurality of UE-specific TDD UL/DL configurations is associated with particular spatial information. The method includes performing communication activity based on the plurality of UE-specific TDD UL/DL configurations, the communication activity being a transmission in a first set of symbols of a slot, where at least one symbol of the first set of symbols of the slot overlaps with a downlink symbol indicated by the cell-specific TDD UL/DL configuration; or a reception in a second set of symbols of the slot, where at least one symbol of the second set of symbols of the slot overlaps with an uplink symbol indicated by the cell-specific TDD UL/DL configuration.

Another method of a UE includes receiving information of a plurality of UE-specific TDD UL/DL configurations, where each of the plurality of UE-specific TDD UL/DL configurations is associated with particular spatial information, and receiving multiple sets of slot format combinations and corresponding multiple starting positions of slot format indicator (“SFI”) indices, each set of slot format combinations and corresponding starting position of SFI index associated with each UE-specific TDD UL/DL configuration. The method includes dynamically determining a symbol type of a semi-static flexible symbol configured by a particular UE-specific TDD UL/DL configuration based on a SFI index and a corresponding set of slot format combinations.

One method at a network node includes transmitting information of a cell-specific TDD UL/DL configuration of a first cell and transmitting information of a plurality of UE-specific TDD UL/DL configurations to at least one UE in the first cell, where each of the plurality of UE-specific TDD UL/DL configurations is associated with particular spatial information. The method includes performing communication activity with the at least one UE based on the plurality of UE-specific TDD UL/DL configurations, the communication activity being a transmission in a first set of symbols of a slot, where at least one symbol of the first set of symbols of the slot overlaps with an uplink symbol indicated by the cell-specific TDD UL/DL configuration; or a reception in a second set of symbols of the slot, where at least one symbol of the second set of symbols of the slot overlaps with a downlink symbol indicated by the cell-specific TDD UL/DL configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a wireless communication system for UE-specific TDD UL/DL configurations for full-duplex operation;

FIG. 1B is a diagram illustrating one embodiment of cell distribution in a time-frequency resource usage in different duplex modes;

FIG. 1C is a diagram illustrating different embodiments of TDD UL/DL configurations;

FIG. 2 is a diagram illustrating one embodiment of a New Radio (“NR”) protocol stack;

FIG. 3 is a diagram illustrating one embodiment of an information element for a serving cell configuration;

FIG. 4 is a diagram illustrating another embodiment of an information element for a configuration of slot format combinations per serving cell;

FIG. 5 is a diagram illustrating one embodiment of a procedure for full duplex operation based on UE-specific TDD UL/DL configurations;

FIG. 6 is a diagram illustrating one embodiment of a procedure for communication activity based on a UE-specific TDD UL/DL configuration;

FIG. 7 is a diagram illustrating another embodiment of a procedure for communication activity based on a UE-specific TDD UL/DL configuration;

FIG. 8 is a diagram illustrating another embodiment of a procedure for communication activity based on a UE-specific TDD UL/DL configuration;

FIG. 9 is a diagram illustrating one embodiment of a procedure for determining a symbol type for a UE-specific TDD UL/DL configuration;

FIG. 10 is a diagram illustrating one embodiment of a XnAP signaling;

FIG. 11 is a block diagram illustrating one embodiment of a user equipment apparatus that may be used for UE-specific TDD UL/DL configurations for full-duplex operation;

FIG. 12 is a block diagram illustrating one embodiment of a network apparatus that may be used for UE-specific TDD UL/DL configurations for full-duplex operation;

FIG. 13 is a flowchart diagram illustrating one embodiment of a first method for UE-specific TDD UL/DL configurations for full-duplex operation;

FIG. 14 is a flowchart diagram illustrating one embodiment of a second method for UE-specific TDD UL/DL configurations for full-duplex operation; and

FIG. 15 is a flowchart diagram illustrating one embodiment of a third method for UE-specific TDD UL/DL configurations for full-duplex operation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, 5 through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for UE-specific TDD UL/DL configurations for full-duplex operation. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Multiple low transmit-power network nodes such as multiple transmission and reception points (“TRPs”) deployed within a cell may be beneficial to overcome channel blockage in high frequency bands and can increase spectral efficiency based on spectral reuse when combined with proper interference management. This disclosure presents methods to support multi-TRP based full duplex cell operation, where at least one TRP transmits Downlink (“DL”) signals/channels while another TRP receives Uplink (“UL”) signals/channels.

In 3GPP Releases 15 and 16 (“Rel-15/16”), a UE does not transmit/receive on cell-specifically configured semi-static DL/UL symbols in a TDD cell. Furthermore, a UE can transmit/receive on cell-specifically configured or group specifically indicated flexible symbols if the UE receives a dynamic indication to transmit/receive on the flexible symbols. Thus, it may be difficult for a cell to accommodate both urgent UL/DL transmissions and semi-statically configured channels/signals.

The disclosed multi-TRP based full duplex cell operation framework allows a network entity to serve DL and UL traffics simultaneously in a cell deployed on unpaired spectrum, not based on self-interference cancellation capability but based on distributed TRP deployments.

According to a first aspect, a UE receives a plurality of dedicated (i.e., UE-specific) TDD UL/DL configurations, each dedicated TDD UL/DL configuration is associated with particular spatial information. According to a second aspect, the UE assumes that a dedicated TDD UL/DL configuration associated with particular spatial information overrides a cell-specific TDD UL/DL configuration for transmission/reception of a UL/DL channel or signal based on the particular spatial information.

According to a third aspect, if configured with a reference dedicated TDD UL/DL configuration, one or more semi-statically configured DL/UL channels and/or signals are received/transmitted according to the reference dedicated TDD UL/DL configuration. For semi-persistently and/or dynamically scheduled DL/UL channels and/or signals, UE performs transmission/reception based on a dedicated TDD UL/DL configuration associated with an indicated spatial information.

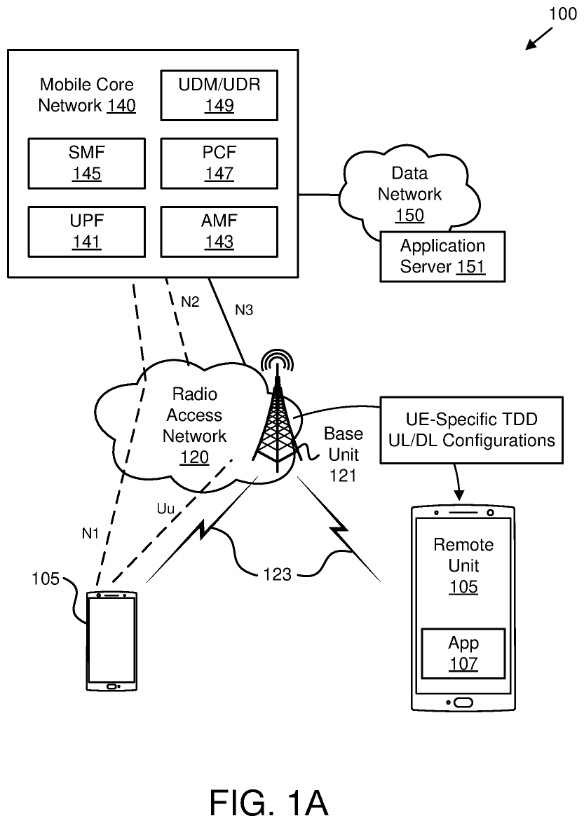

FIG. 1A depicts a wireless communication system 100 for UE-specific TDD UL/DL configurations for full-duplex operation, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1A, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication networks, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and DL communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication (not shown in FIG. 1). Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., Orthogonal Frequency Division Multiplexing (“OFDM”) symbols, subframes, slots, subslots, etc.). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5Q1”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

To facilitate full duplex operation in the multi-TRP environment, the base unit 121 transmits a UE-specific TDD UL/DL configuration 125 to the remote unit 105. The UE-specific TDD UL/DL configuration 125 may indicate at least a set of slot configurations, a slot index for each slot configuration, and a set of symbols and their corresponding symbol types (i.e., downlink, uplink, or flexible). Note that the remote unit 105 may be configured with multiple UE-specific TDD UL/DL configurations 125. Consequently, the remote unit 105 identifies a specific slot format and performs communication activity, such as UL transmission or DL reception.

Note that when the base unit 121 operates in full-duplex mode, the base unit 121 may transmit a cell-specific TDD UL/DL configuration (not shown in FIG. 1A), where the UE-specific TDD UL/DL configuration 125 overrides one or more slot formats of the cell-specific TDD UL/DL configuration. Accordingly, the remote unit 105 may perform UL transmission in a first set of (one or more) symbols of a slot, where at least one symbol of the first set of symbols of the slot overlaps with a downlink symbol indicated by the cell-specific TDD UL/DL configuration. Alternatively, the remote unit 105 may perform DL reception in a second set of (one or more) symbols of the slot, where at least one symbol of the second set of symbols of the slot overlaps with an uplink symbol indicated by the cell-specific TDD UL/DL configuration.

While FIG. 1 depicts components of a 5G RAN and a 5G core network, the described embodiments for UE-specific TDD UL/DL configurations for full-duplex operation apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for UE-specific TDD UL/DL configurations for full-duplex operation.

FIG. 1B depicts examples of different duplexing modes and corresponding frequency and time use. For frequency-division duplexing (“FDD”) mode, a first portion of the frequency band is used for UL transmission and a second portion of the frequency band is used for DL transmission. For pure FDD mode no distinction is made in the time domain between UL and DL transmissions, meaning that UL and DL transmissions may be performed simultaneously using the same time resources. Note that a duplex gap (i.e., guard band) exists in the frequency band separating UL frequencies from DL frequencies (i.e., preventing inter-carrier interference).

For TDD mode, a first portion of the time domain (i.e., a first time slot or first set of time slots) is used for UL transmission and a second portion of the time domain (i.e., a second time slot or second set of time slots) is used for DL transmission. For pure TDD mode no distinction is made in the frequency domain between UL and DL transmissions, meaning that UL and DL transmissions may be performed across the entire frequency band, i.e., using the same frequency resources. Note that a guard period (i.e., time gap) exists in the time domain separating UL time slots from DL time slots (i.e., preventing inter-slot interference). Also note that some wireless communication systems employ combinations of FDD and TDD principles, i.e., separating UL and DL transmissions in both time and frequency.

FDD and TDD are examples of half-duplex operation. In contrast thereto, for Full Duplex (“FD”) mode UL and DL transmissions may be performed across the entire frequency band, i.e., using the same frequency resources or using the same carrier with different subbands of the same carrier, and also using the same time resources. FD operation is characterized by the capability to concurrently transmit and receive at the same time and same frequency resources, which is facilitated by the means of self-interference cancellation (“SIC”) at an FD node. In contrast, half-duplex operation provides, e.g., communication in both directions, but only one direction at a time (i.e., TDD), not simultaneously in both directions.

In unpaired spectrum, TDD is used to avoid interference (e.g., uplink and downlink interference within a network entity and UE-to-UE interference). However, TDD limits UL and DL transmission opportunities and makes it difficult to accommodate urgent UL and DL transmissions simultaneously, especially when DL and UL traffics are asymmetric in a cell. Full duplex operation by a network entity can reduce latency by allowing controlled UL/DL transmissions while on-going DL/UL traffics being served in a carrier.

Multiple low-transmit-power network nodes such as multiple transmission and reception points (TRPs) deployed within a cell may be beneficial, e.g., to overcome channel blockage in high frequency bands, and can increase spectral efficiency based on spectral reuse when combined with proper interference management.

This disclosure presents methods to support multi-TRP-based full-duplex cell operation, where at least one TRP transmits DL signals/channels while another TRP is receiving UL signals/channels.

FIG. 1C depicts various examples of TDD UL/DL configurations 160, according to embodiments of the disclosure. As depicted, different configurations have different numbers and locations of downlink symbols (denoted “D”), uplink symbols (denoted “U”), and flexible symbols (denoted “F”). A symbol marked as Flexible means it can be used for either Uplink or Downlink as per requirement.

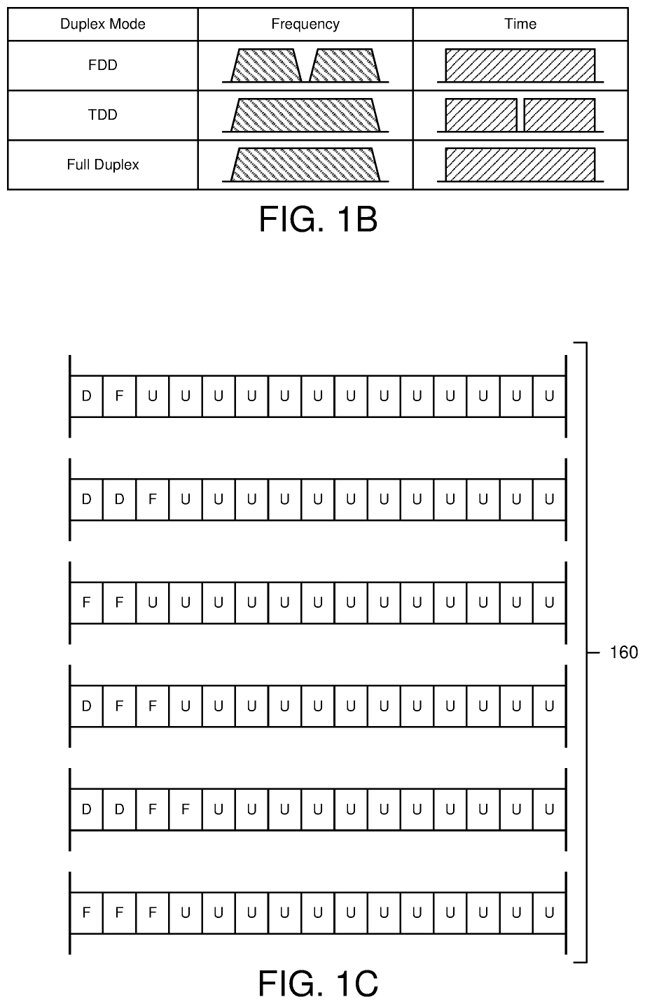

FIG. 2 depicts an NR protocol stack 200, according to embodiments of the disclosure. While FIG. 2 shows the UE 205, the RAN node 210 and an AMF 215 in a 5G core network (“5GC”), these are representatives of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) sublayer 240. The Control Plane protocol stack 203 includes a PHY layer 220, a MAC sublayer 225, an RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

Regarding Physical Uplink Control Channel (“PUCCH”) Formats for Uplink Control Information (“UCI”) transmission, a spatial setting for a PUCCH transmission is provided by PUCCH-SpatialRelationInfo if the UE is configured with a single value for pucch-SpatialRelationInfold; otherwise, if the UE is provided multiple values for PUCCH-SpatialRelationInfo, the UE determines a spatial setting for the PUCCH transmission (e.g., as described in 3GPP Technical Specification (“TS”) 38.321). The UE applies corresponding actions (e.g., as described in 3GPP TS 38.321) and a corresponding setting for a spatial domain filter to transmit PUCCH in the first slot that is after slot k+3·Nₛₗₒₜ^{subframe,μ} where k is the slot where the UE would transmit a PUCCH with Hybrid Automated Repeat Request (“HARQ”) feedback (i.e., HARQ-ACK) information with ACK value corresponding to a Physical Downlink Shared Channel (“PDSCH”) reception providing the PUCCH-SpatialRelationInfo and u is the subcarrier spacing (“SCS”) configuration for the PUCCH. As used herein, “HARQ-ACK” may represent collectively the Positive Acknowledge (“ACK”) and the Negative Acknowledge (“NACK”) and Discontinuous Transmission (“DTX”). ACK means that a Transport Block (“TB”) is correctly received while NACK means a TB is erroneously received and DTX means that no TB was detected.

If PUCCH-SpatialRelationInfo provides ssb-Index, the UE transmits the PUCCH using a same spatial domain filter as for a reception of a Synchronization Signal and/or Physical Broadcast Channel (“SS/PBCH”) block with index provided by ssb-Index for a same serving cell or, if servingCellId is provided, for a serving cell indicated by servingCellId.

Else, if PUCCH-SpatialRelationInfo provides csi-RS-Index, the UE transmits the PUCCH using a same spatial domain filter as for a reception of a Channel State Information Reference Signal (“CSI-RS”) with resource index provided by csi-RS-Index for a same serving cell or, if servingCellId is provided, for a serving cell indicated by servingCellId

Else PUCCH-SpatialRelationInfo provides srs, the UE transmits the PUCCH using a same spatial domain filter as for a transmission of a Sounding Reference Signal (“SRS”) with resource index provided by resource for a same serving cell and/or active Uplink Bandwidth Part (“UL BWP”) or, if servingCellId and/or uplinkBWP are provided, for a serving cell indicated by servingCellId and/or for an UL BWP indicated by uplinkBWP

If a UE: A) is not provided pathlossReferenceRSs in PUCCH-PowerControl, B) is provided enableDefaultBeamPL-ForPUCCH, C) is not provided PUCCH-SpatialRelationInfo, and D) is not provided coresetPoolIndex value of 1 for any Control Resource Set (“CORESET”), or is provided coresetPoolIndex value of 1 for all CORESETs, in ControlResourceSet and no codepoint of a Transmission Configuration Indicator (“TCI”) field, if any, in a Downlink Control Information (“DCI”) format of any search space set maps to two TCI states, then a spatial setting for a PUCCH transmission from the UE is same as a spatial setting for Physical Downlink Control Channel (“PDCCH”) receptions by the UE in the CORESET with the lowest ID on the active Downlink Bandwidth Part (“DL BWP”) of the Primary Cell (“PCell”). For a PUCCH transmission over multiple slots, a same spatial setting applies to the PUCCH transmission in each of the multiple slots.

Regarding slot configuration, if the UE is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon.

The tdd-UL-DL-ConfigurationDedicated provides: A) a set of slot configurations by slotSpecificConfigurationsToAddModList; B) for each slot configuration from the set of slot configurations; C) a slot index for a slot provided by slotindex; and D) a set of symbols for a slot by symbols where: i) if symbols=allDownlink, all symbols in the slot are downlink; ii) if symbols=allUplink, all symbols in the slot are uplink; and iii) if symbols=explicit, nrofDownlinkSymbols provides a number of downlink first symbols in the slot and nrofUplinkSymbols provides a number of uplink last symbols in the slot.

If information element (“IE”) nrofDownlinkSymbols is not provided, there are no downlink first symbols in the slot and if IE nrofUplinkSymbols is not provided, there are no uplink last symbols in the slot. The remaining symbols in the slot are flexible.

If a UE is not configured to monitor PDCCH for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, then the UE receives PDSCH or CSI-RS in the set of symbols of the slot if the UE receives a corresponding indication by a DCI format. Additionally, the UE transmits Physical Uplink Shared Channel (“PUSCH”), PUCCH, Physical Random Access Channel (“PRACH”), or SRS in the set of symbols of the slot if the UE receives a corresponding indication by a DCI format, a Random-Access Response (“RAR”) UL grant, fallbackRAR UL grant, or successRAR.

For a set of symbols of a slot that are indicated to a UE as flexible by tdd-UL-DL-ConfigurationCommon, and tdd-UL-DL-ConfigurationDedicated if provided, the UE does not expect to receive both dedicated higher layer parameters configuring transmission from the UE in the set of symbols of the slot and dedicated higher layer parameters configuring reception by the UE in the set of symbols of the slot.

Regarding quasi co-location (“QCL”) of antenna ports, independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qel-Type set to ‘typeD’,

The UE may assume that the Demodulation Reference Signal (“DM-RS”) ports of PDSCH(s) of a serving cell are quasi co-located with the Reference Signal(s) (“RS(s)”) with respect to the QCL parameter(s) used for PDCCH quasi co-location indication of the CORESET associated with a monitored search space with the lowest controlResourceSetId in the latest slot in which one or more CORESETs within the active bandwidth part (“BWP”) of the serving cell are monitored by the UE. In this case, if the qel-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band Carrier Aggregation (“CA”) case (when PDSCH and the CORESET are in different component carriers (“CCs”)).

If a UE is configured with enableDefaultTCIStatePerCoresetPoolIndex and the UE is configured by higher layer parameter PDCCH-Config that contains two different values of coresetPoolIndex in different ControlResourceSets, then the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).

Regarding UE sounding procedure, when the higher layer parameter usage is set to ‘beamManagement’, only one Sounding Reference Signal (“SRS”) resource in each of multiple SRS resource sets may be transmitted at a given time instant, but the SRS resources in different SRS resource sets with the same time domain behavior in the same Bandwidth Part (“BWP”) may be transmitted simultaneously.

The following SRS parameters are semi-statically configurable by higher layer parameter SRS-Resource or SRS-PosResource.

The configuration of the spatial relation between a reference RS and the target SRS, where the higher layer parameter spatialRelationInfo or spatial RelationInfoPos, if configured, contains the ID of the reference RS. The reference RS may be an SS/PBCH block (“SSB”), CSI-RS configured on serving cell indicated by higher layer parameter servingCellId if present, same serving cell as the target SRS otherwise, or an SRS configured on uplink BWP indicated by the higher layer parameter uplinkBWP, and serving cell indicated by the higher layer parameter servingCellId if present, same serving cell as the target SRS otherwise. When the target SRS is configured by the higher layer parameter SRS-PosResourceSet, the reference RS may also be a Downlink Positioning Reference Signal (“DL PRS”) configured on a serving cell or a non-serving cell indicated by the higher layer parameter dl-PRS, or an SS/PBCH block of a non-serving cell indicated by the higher layer parameter ssb-Ncell.

If the UE is configured with the higher layer parameter spatialRelationInfo or spatialRelationInfoPos containing the ID of a reference ‘ssb-Index’, ‘ssb-IndexServing’, or ‘ssb-IndexNcell’, the UE is to transmit the target SRS resource with the same spatial domain transmission filter used for the reception of the reference SS/PBCH block, if the higher layer parameter spatialRelationInfo or spatialRelationInfoPos contains the ID of a reference ‘csi-RS-Index’ or ‘csi-RS-IndexServing’, the UE is to transmit the target SRS resource with the same spatial domain transmission filter used for the reception of the reference periodic CSI-RS or of the reference semi-persistent CSI-RS, if the higher layer parameter spatialRelationInfo or spatialRelationInfoPos containing the ID of a reference ‘srs’ or ‘srs-spatialRelation’, the UE is to transmit the target SRS resource with the same spatial domain transmission filter used for the transmission of the reference periodic SRS. When the SRS is configured by the higher layer parameter SRS-PosResource and if the higher layer parameter spatialRelationInfoPos contains the ID of a reference ‘dl-PRS’, the UE is to transmit the target SRS resource with the same spatial domain transmission filter used for the reception of the reference DL PRS.

For a UE configured with one or more SRS resource configuration(s), and when the higher layer parameter resourceType in SRS-Resource or SRS-PosResource is set to ‘aperiodic’.

When a UE receives an spatial relation update command (e.g., as described in clause 6.1.3.26 of 3GPP TS 38.321), for an SRS resource configured with the higher layer parameter SRS-Resource, and when the HARQ-ACK corresponding to the PDSCH carrying the update command is transmitted in slot n, the corresponding actions (e.g., as described in 3GPP TS 38.321) and the UE assumptions on updating spatial relation for the SRS resource is to be applied for SRS transmission starting from the first slot that is after slot n+3·Nₛₗₒₜ^{subframe,μ}.

The update command contains spatial relation assumptions provided by a list of references to reference signal IDs, one per element of the updated SRS resource set. Each ID in the list refers to a reference SS/PBCH block, non-zero power (“NZP”) CSI-RS resource configured on serving cell indicated by Resource Serving Cell ID field in the update command if present, same serving cell as the SRS resource set otherwise, or SRS resource configured on serving cell and uplink bandwidth part indicated by Resource Serving Cell ID field and Resource BWP ID field in the update command if present, same serving cell and bandwidth part as the SRS resource set otherwise. When the UE is configured with the higher layer parameter usage in SRS-ResourceSet set to ‘antennaSwitching’, the UE is to not expect to be configured with different spatial relations for SRS resources in the same SRS resource set.

When a spatialRelationInfo is activated/updated for a semi-persistent or aperiodic SRS resource configured by the higher layer parameter SRS-Resource by a MAC Control Element (“CE”) for a set of Component Carriers (“CCs”) and/or Bandwidth Parts (“BWPs”), where the applicable list of CCs is indicated by higher layer parameter simultaneousSpatial-UpdatedList1 or simultaneousSpatial-UpdatedList2, the spatialRelationInfo is applied for the semi-persistent or aperiodic SRS resource(s) with the same SRS resource ID for all the BWPs in the indicated CCs.

When the higher layer parameter enable DefaultBeamPL-ForSRS is set to ‘enabled’, and if the higher layer parameter spatialRelationInfo for the SRS resource, except for the SRS resource with the higher layer parameter usage in SRS-ResourceSet set to ‘beamManagement’ or for the SRS resource with the higher layer parameter usage in SRS-ResourceSet set to ‘nonCodebook’ with configuration of associatedCSI-RS or for the SRS resource configured by the higher layer parameter SRS-PosResourceSet, is not configured in FR2 and if the UE is not configured with higher layer parameter(s) pathlossReferenceRS, and if the UE is not configured with different values of coresetPoolIndex in ControlResourceSets, and is not provided at least one TCI codepoint mapped with two TCI states, the UE is to transmit the target SRS resource in an active UL BWP of a CC: according to the spatial relation, if applicable, with a reference to the RS configured with qel-Type set to ‘typeD’ corresponding to the QCL assumption of the CORESET with the lowest controlResourceSetId in the active DL BWP in the CC. Alternatively, according to the spatial relation, if applicable, with a reference to the RS configured with qel-Type set to ‘typeD’ in the activated TCI state with the lowest ID applicable to PDSCH in the active DL BWP of the CC if the UE is not configured with any CORESET in the active DL BWP of the CC.

When a cell is provided by a network entity (e.g., gNB) consisting of multiple distributed TRPs (or network nodes), different TRPs in the cell may serve different directions of traffics or communication, e.g., one TRP transmitting DL signals/channels while another TRP receiving UL signals/channels. Full duplex cell operation can be achieved by multiple TRPs being operated with different TDD UL/DL slot formats in the cell.

According to embodiments of a first solution, a UE receives a plurality of dedicated (i.e., UE-specific) TDD UL/DL configurations (e.g., parameter tdd-UL-DL-ConfigurationDedicatedList) in a serving cell configuration. If configured, the UE assumes that a dedicated TDD UL/DL configuration indicated by a parameter TDD-UL-DL-ConfigDedicated included in tdd-UL-DL-ConfigurationDedicatedList overrides a cell-specific TDD UL/DL configuration (e.g., indicated by a parameter tdd-UL-DL-ConfigurationCommon) for transmission/reception of a UL/DL channel or signal based on particular spatial information, where the dedicated TDD UL/DL configuration (indicated by the parameter TDD-UL-DL-ConfigDedicated) is associated with the particular spatial information. When the UE would transmit/receive the UL/DL channel or signal based on the particular spatial information, the UE identifies a symbol type(s) (i.e., semi-static UL, DL, or flexible symbol) based on the corresponding dedicated TDD UL/DL configuration for symbols allocated for the UL/DL channel or signal and may determine whether to transmit/receive the UL/DL channel or signal based on the identified symbol type(s).

In one implementation, each dedicated TDD UL/DL configuration of the plurality of dedicated TDD UL/DL configurations is associated with each TRP—or each group of TRPs—in a cell.

In one example, if a UE is configured with a plurality of dedicated TDD UL/DL configurations, the UE shall assume that a first dedicated TDD UL/DL configuration is associated with one or more control resource sets (“CORESETs”) of coresetPoolIndex value of ‘0’ in an active DL BWP, a second dedicated TDD UL/DL configuration is associated with one or more CORESETs of coresetPoolIndex value of ‘1’ in the active DL BWP, and so on. The UE receives one or more PDCCHs on the one or more CORESETs of coresetPoolIndex value of ‘0’ according to the first dedicated TDD UL/DL configuration, receives one or more PDCCHs on the one or more CORESETs of coresetPoolIndex value of ‘1’ according to the second dedicated TDD UL/DL configuration, and so on.

In an example, if a UE is configured with a plurality of dedicated TDD UL/DL configurations, the UE shall assume that a first dedicated TDD UL/DL configuration is associated with a first set of PDSCH Transmit Configuration Indicator (“TCI”) states in an active DL BWP, a second dedicated TDD UL/DL configuration is associated with a second set of PDSCH TCI states in the active DL BWP, and so on. The UE receives one or more PDSCHs with at least one TCI state from the first set of PDSCH TCI states according to the first dedicated TDD UL/DL configuration, receives one or more PDSCHs with at least one TCI state from the second set of PDSCH TCI states according to the second dedicated TDD UL/DL configuration, and so on.

In another example, if a UE is configured with a plurality of dedicated TDD UL/DL configurations and configured with a plurality of sounding reference signal (“SRS”) resource sets for PUSCH (e.g., parameter SRS-ResourceSet with usage set to ‘codebook’ or ‘nonCodebook’), the UE shall assume that a first dedicated TDD UL/DL configuration is associated with a first SRS resource set for PUSCH (e.g., SRS-ResourceSet with usage set to ‘codebook’ or ‘nonCodebook’ with the lowest srs-ResourceSetId value) in an active UL BWP, a second dedicated TDD UL/DL configuration is associated with a second SRS resource set for PUSCH in the active UL BWP, and so on.

The UE transmits one or more PUSCHs based on the first SRS resource set for PUSCH according to the first dedicated TDD UL/DL configuration, transmits one or more PUSCHs based on the second SRS resource set for PUSCH according to the second dedicated TDD UL/DL configuration, and so on. In an implementation, the first SRS resource set is associated with a first UE antenna panel, and the second SRS resource set is associated with a second UE antenna panel.

In an example, if a UE is configured with a plurality of dedicated TDD UL/DL configurations, the UE shall assume that a first dedicated TDD UL/DL configuration is associated with a first set of PUCCH spatial relation information (e.g., parameter pucch-SpatialRelationInfoPoolIndex value as ‘0’) in an active UL BWP, a second dedicated TDD UL/DL configuration is associated with a second set of PUCCH spatial relation information (e.g., parameter pucch-SpatialRelationInfoPoolIndex value as ‘1’) in the active UL BWP, and so on. The UE transmits one or more PUCCHs based on the first set of spatial relation information according to the first dedicated TDD UL/DL configuration, transmits one or more PUCCHs based on the second set of spatial relation information according to the second dedicated TDD UL/DL configuration, and so on.

In an implementation, a set of spatial relation information has the same pucch-SpatialRelationInfoPoolIndex value, where the parameter pucch-SpatialRelationInfoPoolIndex is included in PUCCH-SpatialRelationInfo. In an implementation, the UE assumes the parameter pucch-SpatialRelationInfoPoolIndex value as ‘0,’ if PUCCH-SpatialRelationInfo does not include the parameter pucch-SpatialRelationInfoPoolIndex.

In an example, if a UE is configured with a plurality of dedicated TDD UL/DL configurations, the UE shall assume that a first dedicated TDD UL/DL configuration is associated with a spatial information first set of SRS relation (e.g., parameter srs-SpatialRelationInfoPoolIndex value as ‘0’) in an active DL BWP, a second dedicated TDD UL/DL configuration is associated with a second set of SRS spatial relation information (e.g., parameter srs-SpatialRelationInfoPoolIndex value as ‘1’) in the active DL BWP, and so on. The UE transmits one or more SRS based on the first set of SRS spatial relation information according to the first dedicated TDD UL/DL configuration, transmits one or more SRS based on the second set of SRS spatial relation information according to the second dedicated TDD UL/DL configuration, and so on.

In an implementation, a set of SRS spatial relation information has the same srs-SpatialRelationInfoPoolIndex value, where the parameter srs-SpatialRelationInfoPoolIndex is included in SRS-SpatialRelationInfo. The UE assumes the parameter srs-SpatialRelationInfoPoolIndex value as ‘0,’ if SRS-SpatialRelationInfo does not include the parameter srs-SpatialRelationInfoPoolIndex.

In an example, if a UE is configured with a plurality of dedicated TDD UL/DL configurations, the UE shall assume that a first dedicated TDD UL/DL configuration is associated with a first set of UL TCI states in an active UL BWP, a second dedicated TDD UL/DL configuration is associated with a second set of UL TCI states in the active UL BWP, and so on. The UE transmits one or more PUSCHs/PUCCHs based on the first set of UL TCI states according to the first dedicated TDD UL/DL configuration, transmits one or more PUSCHs/PUCCHs based on the second set of UL TCI states according to the second dedicated TDD UL/DL configuration, and so on.

In one example, UL TCI states are provided if the UE is configured with Rel-17 separate DL/UL TCI by RRC signaling. The UL TCI state comprises a source reference signal which provides a reference for determining UL spatial domain transmission filter for the UL transmission (e.g., dynamic-grant/configured-grant based PUSCH, dedicated PUCCH resources in a CC or across a set of configured CCs/BWPs).

In an example, if a UE is configured with a plurality of dedicated TDD UL/DL configurations, the UE shall assume that a first dedicated TDD UL/DL configuration is associated with a first set of joint DL/UL TCI states in an active DL/UL BWP, a second dedicated TDD UL/DL configuration is associated with a second set of joint DL/UL TCI states in the active DL/UL BWP, and so on.

The UE receives one or more PDSCHs with at least one TCI state from the first set of joint TCI states according to the first dedicated TDD UL/DL configuration, receives one or more PDSCHs with at least one TCI state from the second set of joint TCI states according to the second dedicated TDD UL/DL configuration, and so on. The UE transmits one or more PUSCHs/PUCCHs based on the first set of joint TCI states according to the first dedicated TDD UL/DL configuration, transmits one or more PUSCHs/PUCCHs based on the second set of joint TCI states according to the second dedicated TDD UL/DL configuration, and so on.

In one example, joint DL/UL TCI states are provided if the UE is configured with Rel-17 joint DL/UL TCI by RRC signaling (e.g., configuration of Rel-17 joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for UE-dedicated PDCCH/PDSCH) and is used to determine UL spatial transmission filter (e.g., for UE-dedicated PUSCH/PUCCH) for a CC or across a set of configured CCs/BWPs.

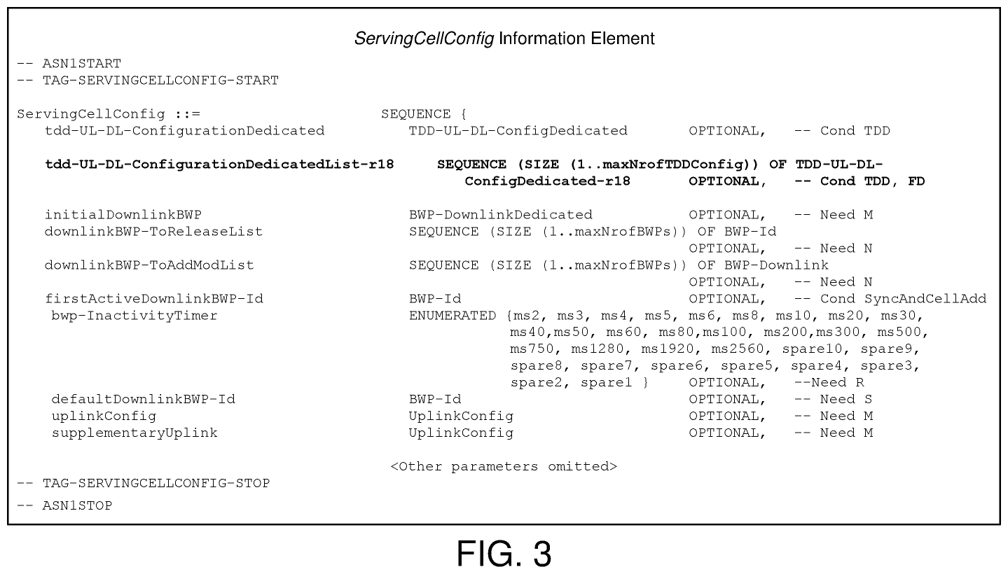

In one example, the UL spatial transmission filter is derived from the Reference Signal (“RS”) of DL QCL Type D in the joint TCI state. The spatial setting of the UL transmission may be according to the spatial relation with a reference to the source RS configured with qel-Type set to ‘typeD’ in the joint TCI state. In one implementation, if a UE is configured with a plurality of dedicated TDD UL/DL configurations, the UE may further be configured with multiple sets of slot format combinations and corresponding multiple starting positions (bits) of slot format indicator (“SFI”)-indexes within a DCI payload of DCI format 2_0 as shown in FIG. 4, where each set of slot format combinations and a corresponding starting position of SFI-index within the DCI payload are associated with each dedicated TDD UL/DL configuration. The UE may dynamically determine a symbol type of a semi-static flexible symbol configured by a dedicated TDD UL/DL configuration of the plurality of dedicated TDD UL/DL configuration, based on an SFI-index indicated in a corresponding DCI bit-field location and a corresponding set of slot format combinations.

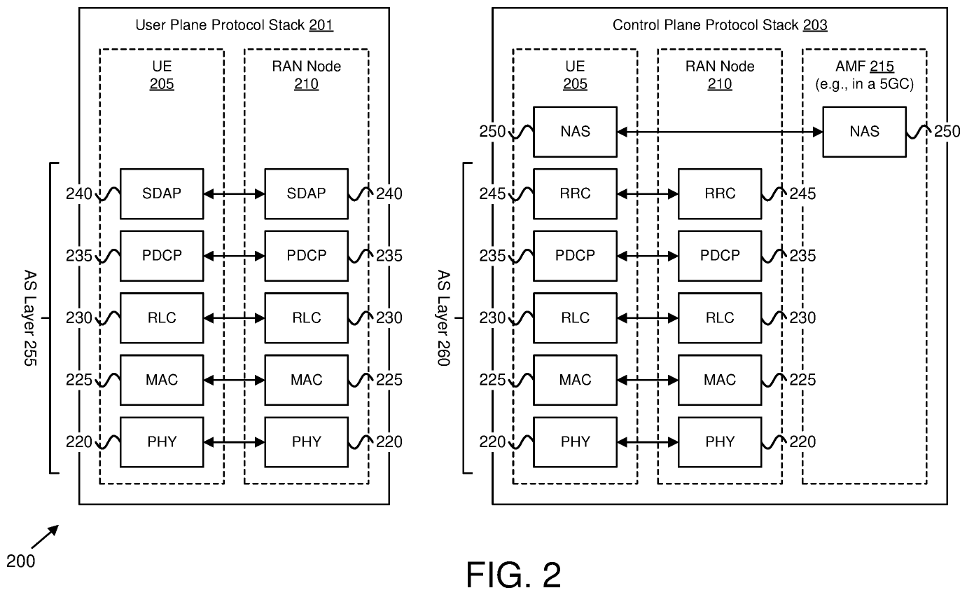

FIG. 3 depicts a first example of an information element (“IE”) for a serving cell configuration, according to embodiments of the disclosure. The IE ServingCellConfig is used to configure (add or modify) the UE with a serving cell, which may be the Special Cell (“SpCell,” i.e., a PCell or Primary Secondary Cell (“PSCell”) or a Secondary Cell (“SCell”) of a Master Cell Group (“MCG”) or Secondary Cell Group (“SCG”). The parameters herein are mostly UE specific but partly also cell specific (e.g., in additionally configured bandwidth parts). Reconfiguration between a PUCCH and PUCCH-less SCell is only supported using an SCell Release and Add routines. The Abstract Syntax Notation 1 (“ASN.1”) keyword “SEQUENCE” in the example codes of the present disclosure is used to create a list of parameters.

FIG. 4 depicts a second example of an information element (“IE”) for a configuration of slot format combinations per serving cell, according to embodiments of the disclosure. The IE SlotFormatCombinationsPerCell is used to configure one or more SlotFormatCombinations applicable for one serving cell (see 3GPP TS 38.213, clause 11.1.1). If multiple SlotFormatCombinations are configured in a cell, each SlotFormatCombinations corresponds to each UE-specific TDD UL/DL configuration of the cell.

Here, the parameter ‘positionInDCI-r18’ indicates the (starting) position (bit) of the slotFormatCombinationId (SFI-Index) for this UE-specific TDD UL/DL configuration (tdd-UL-DL-ConfigDedicatedId) for this serving cell (servingCellId) within the DCI payload (see, e.g., TS 38.213, clause 11.1.1).

The parameter ‘servingCellId’ indicates the ID of the serving cell for which the slotFormatCombinations or fullDuplex-SlotFormatCombinationsList are applicable.

The parameter ‘slotFormatCombinations-r18’ indicates a list with SlotFormatCombinations for this UE-specific TDD UL/DL configuration (tdd-UL-DL-ConfigDedicatedId) for this serving cell (servingCellId). Each SlotFormatCombination comprises of one or more SlotFormats (see, e.g., 3GPP TS 38.211, clause 4.3.2). The total number of slotFormats in the slotFormatCombinations list does not exceed 512.

In another embodiment, a UE receives a plurality of dedicated TDD UL/DL configurations (e.g., parameter tdd-UL-DL-ConfigurationDedicatedList) and also receives information of a reference dedicated TDD UL/DL configuration selected from the plurality of dedicated TDD UL/DL configurations. In one example, the UE determines a reference dedicated TDD UL/DL configuration as a first entry (index 0) parameter TDD-UL-DL-ConfigDedicated-r18 in the parameter tdd-UL-DL-ConfigurationDedicatedList-r18, which may be used similarly as the legacy parameter TDD-UL-DL-ConfigDedicated. Alternatively, in another example, a legacy parameter TDD-UL-DL-ConfigDedicated (if configured) may be used as a reference dedicated TDD UL/DL configuration, while the said parameter tdd-UL-DL-ConfigurationDedicatedList-r18 is used according to an embodiment of this disclosure.

In either case, if a reference dedicated TDD UL/DL configuration is configured, the UE shall assume that one or more semi-statically configured DL/UL channels and/or signals (e.g., a CORESET, a periodic channel state information-reference signal (“CSI-RS”), a synchronization signal/physical broadcast channel (“SS/PBCH”) block, a periodic SRS, a PUCCH for periodic Channel State Information (“CSI”) reporting, a type1 configured grant (“CG”) PUSCH) are received/transmitted according to the reference dedicated TDD UL/DL configuration. For semi-persistently (e.g., semi-persistent SRS, semi-persistent CSI-RS) and/or dynamically scheduled DL/UL channels and/or signals (e.g., aperiodic SRS, aperiodic CSI-RS), the UE performs transmission/reception based on a dedicated TDD UL/DL configuration associated with an indicated spatial information.

In an implementation, a UE assumes that a reference dedicated TDD UL/DL configuration selected from tdd-UL-DL-ConfigurationDedicatedList overrides only flexible symbols per slot over the number of slots as provided by tdd-UL-DL-ConfigurationCommon. In another implementation, the UE assumes that the reference dedicated TDD UL/DL configuration overrides the cell-specific TDD UL/DL configuration (i.e., tdd-UL-DL-ConfigurationCommon).

In one implementation, a UE receives association information of each subset of DL reference signals (e.g., as SS/PBCH block (“SSB”) indices, non-zero power (“NZP”)-CSI-RS resource identities) associated with each dedicated TDD UL/DL configuration of a plurality (said list/sequence) of dedicated TDD UL/DL configurations. When a spatial information indicated for a semi-persistently or dynamically scheduled channel or signal comprises an indication of a DL reference signal (e.g., a SSB index, NZP-CSI-RS ID), the UE identifies a symbol type(s) (e.g., semi-static UL, DL, or flexible symbol) for symbols allocated for the scheduled channel or signal based on a dedicated TDD UL/DL configuration associated with the indicated DL reference signal. Further, the UE may determine whether to transmit/receive a part of (e.g., a repetition) or a full of the scheduled channel or signal based on the identified symbol type(s).

In another implementation, a UE receives association information of each subset of SRS resources associated with each dedicated TDD UL/DL configuration of a plurality of dedicated TDD UL/DL configurations. When a spatial information indicated for a semi-persistently or dynamically scheduled channel or signal comprises an indication of an SRS resource (e.g., an SRS resource ID), the UE may determine a symbol type(s) (i.e., semi-static UL, DL, or flexible symbol) for symbols allocated for the scheduled channel or signal based on a dedicated TDD UL/DL configuration associated with the indicated SRS resource.

In an implementation, if a UE is configured to monitor a DCI format 2_0, for a set of symbols of a slot indicated as DL/UL by a reference dedicated TDD UL/DL configuration, the UE does not expect to detect the DCI format 2_0 with a SFI-index field value indicating the set of symbols of the slot as UL/DL, respectively, or as flexible. A network entity may configure a group of UEs, which are configured with a same dedicated TDD UL/DL configuration as a reference dedicated TDD UL/DL configuration, with a same slot format indication configuration (e.g., a Slot Format Indicator Radio Network Temporary Identifier (“SFI-RNTI”) value, a DCI payload size, slot format combinations, DCI bit field location).

In another implementation, for a set of symbols of a slot indicated to a UE as flexible by a reference TDD-UL-DL-ConfigDedicated, the UE transmits/receives or does not transmit/receive according to rules specified, for example, in Rel-15/16 NR for symbols indicated as flexible by tdd-UL-DL-ConfigurationCommon and existing (Rel-15/16) NR parameter tdd-UL-DL-ConfigurationDedicated. For example, the UE assumes that flexible symbols in a CORESET (e.g., CORESET symbol indicated as flexible by the reference TDD-UL-DL-ConfigDedicated) configured to the UE for PDCCH monitoring in a DL BWP are downlink symbols if the UE does not detect an SFI-index field value in DCI format 2_0 indicating the set of symbols of the slot as flexible or uplink and the UE does not detect a DCI format indicating to the UE to transmit SRS, PUSCH, PUCCH, or PRACH in the set of symbols.

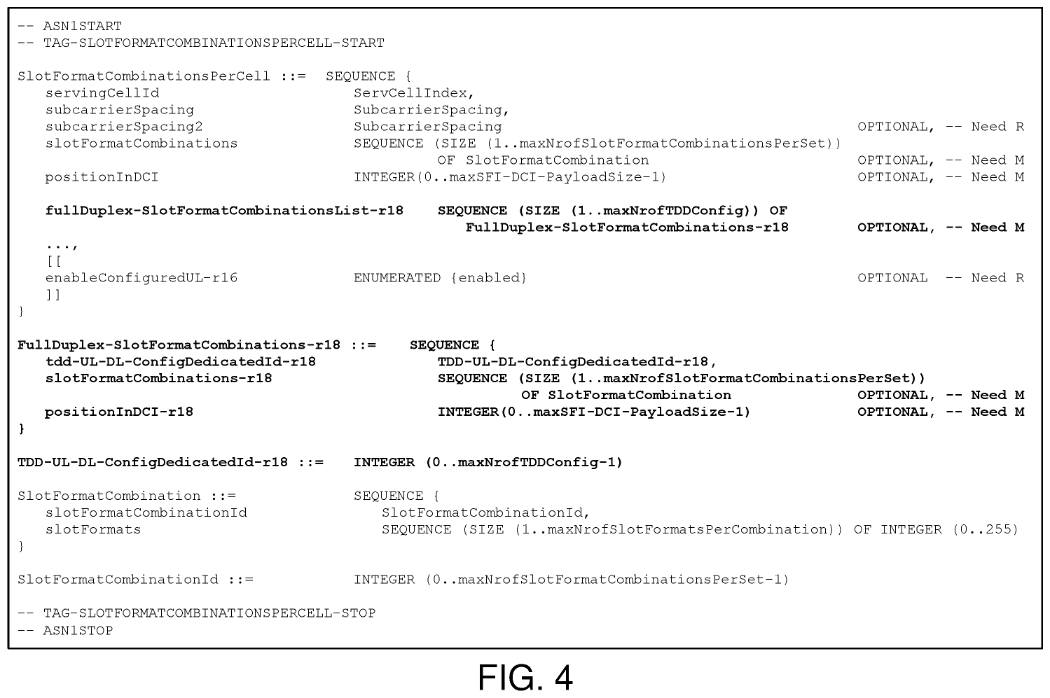

FIG. 5 depicts call flow of an exemplary procedure 500 for performing transmission/reception (“Tx/Rx”) based on a UE-specific (i.e., dedicated) TDD UL/DL configuration, according to embodiments of the disclosure. The procedure 500 involves the UE 205 (e.g., one embodiment of the remote unit 105) and the RAN node 210 (e.g., a gNB or an embodiment of the base unit 121) which provides a serving cell.

At Step 1, the RAN node 210 transmits a cell-specific TDD UL/DL configuration to the UE 205 in the serving cell (see messaging 505). Note that the cell-specific TDD UL/DL configuration may be transmitted (e.g., broadcast) to multiple UEs in the serving cell.

At Step 2, the RAN node 210 transmits multiple UE-specific (i.e., dedicated) TDD UL/DL configurations to the UE 205 (see messaging 510). The details and contents of the UE-specific TDD UL/DL configurations are according to the embodiments described herein.

At Step 3, the RAN node 210 and UE 205 perform Tx/Rx activity based on the UE-specific TDD UL/DL configurations (see block 515). In particular, the UE 205 may transmit a UL transmission to the RAN node 210 in a first set of (one or more) symbols of a slot, where at least one symbol of the first set of symbols of the slot overlaps with a downlink symbol indicated by the cell-specific TDD UL/DL configuration. Alternatively, the UE 205 may receive a DL transmission from the RAN node 210 in a second set of (one or more) symbols of the slot, where at least one symbol of the second set of symbols of the slot overlaps with an uplink symbol indicated by the cell-specific TDD UL/DL configuration.

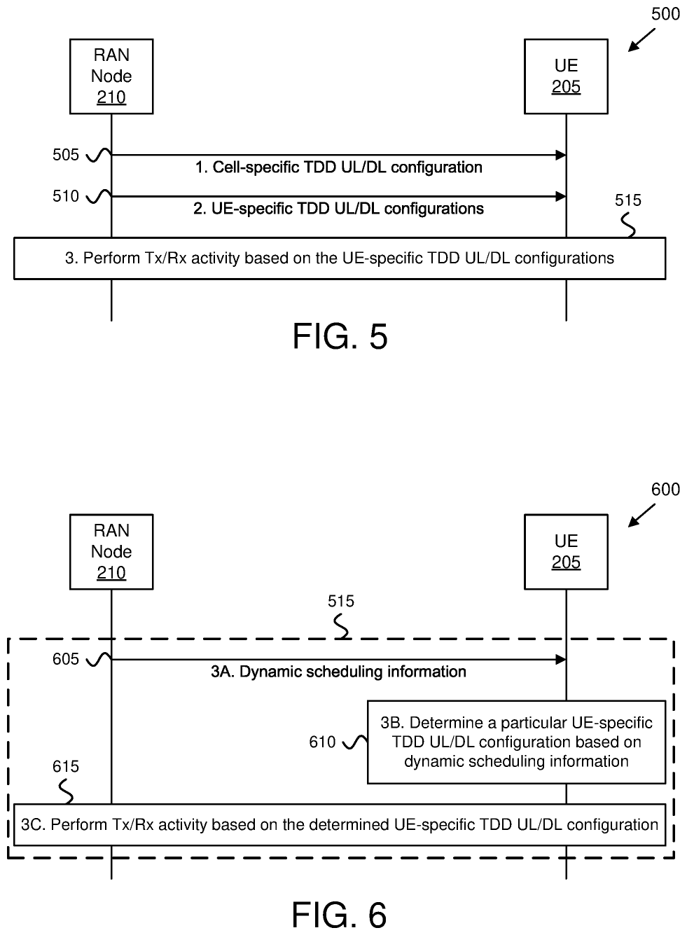

FIG. 6 depicts call flow of an exemplary procedure 600 for performing transmission/reception (“Tx/Rx”) based on a UE-specific (i.e., dedicated) TDD UL/DL configuration, according to embodiments of the disclosure. The procedure 600 illustrates one embodiment of Step 3 (i.e., block 515) depicted in FIG. 5.

At Step 3A, the RAN node 210 transmits dynamic scheduling information (e.g., DCI) to the UE 205 (see messaging 605). Here, the dynamically scheduled DL/UL channels (and/or signals) are associated with spatial information.

At Step 3B, the UE 205 determines a particular UE-specific TDD UL/DL configuration based on the dynamic scheduling information (see block 610). Here, the UE 205 may use the indicated spatial information associated with the dynamically scheduled DL/UL channels (and/or signals) to select the particular UE-specific TDD UL/DL configuration.

At Step 3C, the RAN node 210 and UE 205 perform Tx/Rx activity using the particular UE-specific TDD UL/DL configuration (see block 615). In particular, the RAN node 210 may receive a UL transmission from the UE 205 in a first set of (one or more) symbols of a slot, where at least one symbol of the first set of symbols of the slot overlaps with a downlink symbol indicated by the cell-specific TDD UL/DL configuration. Alternatively, the UE 205 may receive a DL transmission from the RAN node 210 in a second set of (one or more) symbols of the slot, where at least one symbol of the second set of symbols of the slot overlaps with an uplink symbol indicated by the cell-specific TDD UL/DL configuration.

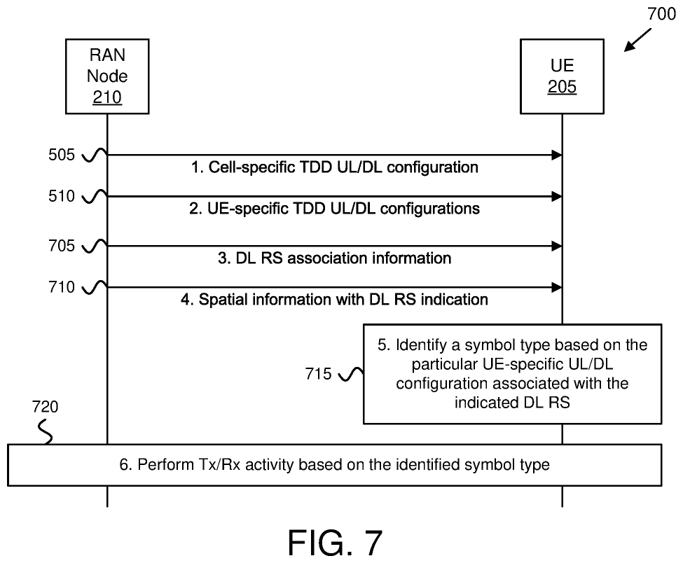

FIG. 7 depicts call flow of an exemplary procedure 700 for performing transmission/reception (“Tx/Rx”) based on a UE-specific (i.e., dedicated) TDD UL/DL configuration, according to embodiments of the disclosure. The procedure 700 illustrates an extension of the procedure 500.

At Step 1, the RAN node 210 transmits a cell-specific TDD UL/DL configuration to the UE 205 in the serving cell (see messaging 505).

At Step 2, the RAN node 210 transmits multiple UE-specific (i.e., dedicated) TDD UL/DL configurations to the UE 205 (see messaging 510). Steps 1 and 2 are described above with reference to FIG. 5.

At Step 3, the RAN node 210 transmits DL RS information to the UE 205 (see messaging 705). For example, the UE 205 may receive information associating a subset of DL RS with a UE-specific TDD UL/DL configuration.

At Step 4, the RAN node 210 transmits spatial information comprising an indication of a particular DL RS (see messaging 710).

At Step 5, the UE 205 identifies a symbol type based on the particular UE-specific TDD UL/DL configuration associated with the indicated DL RS (see block 715).

At Step 6, the RAN node 210 and UE 205 perform Tx/Rx activity based on the identified symbol type (see block 720). In particular, the RAN node 210 may receive a UL transmission from the UE 205 in a first set of (one or more) symbols of a slot, where at least one symbol of the first set of symbols of the slot overlaps with a downlink symbol indicated by the cell-specific TDD UL/DL configuration. Alternatively, the UE 205 may receive a DL transmission from the RAN node 210 in a second set of (one or more) symbols of the slot, where at least one symbol of the second set of symbols of the slot overlaps with an uplink symbol indicated by the cell-specific TDD UL/DL configuration.

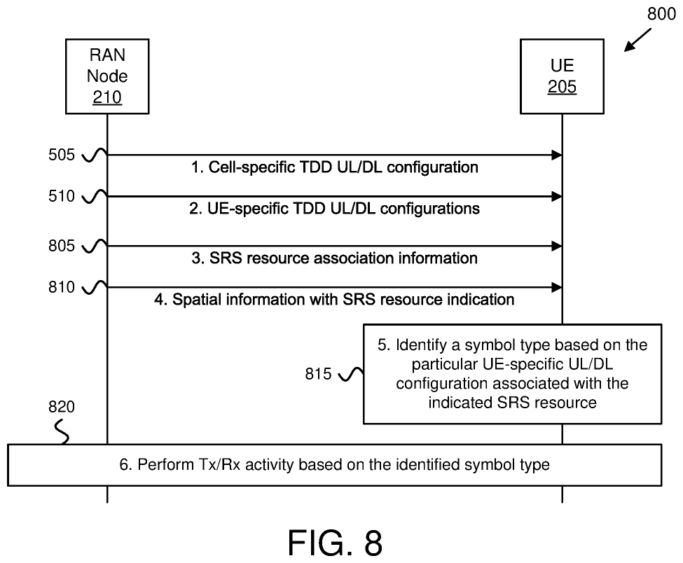

FIG. 8 depicts call flow of an exemplary procedure 800 for performing transmission/reception (“Tx/Rx”) based on a UE-specific (i.e., dedicated) TDD UL/DL configuration, according to embodiments of the disclosure. The procedure 800 illustrates an extension of the procedure 500.

At Step 1, the RAN node 210 transmits a cell-specific TDD UL/DL configuration to the UE 205 in the serving cell (see messaging 505).

At Step 2, the RAN node 210 transmits multiple UE-specific (i.e., dedicated) TDD UL/DL configurations to the UE 205 (see messaging 510). Steps 1 and 2 are described above with reference to FIG. 5.

At Step 3, the RAN node 210 transmits SRS resource information to the UE 205 (see messaging 805). For example, the UE 205 may receive information associating a subset of SRS resources with a UE-specific TDD UL/DL configuration.

At Step 4, the RAN node 210 transmits spatial information comprising an indication of a particular SRS resource (see messaging 810).

At Step 5, the UE 205 identifies a symbol type based on the particular UE-specific TDD UL/DL configuration associated with the indicated SRS resource (see block 815).

At Step 6, the RAN node 210 and UE 205 perform Tx/Rx activity based on the identified symbol type (see block 820). In particular, the RAN node 210 may receive a UL transmission from the UE 205 in a first set of (one or more) symbols of a slot, where at least one symbol of the first set of symbols of the slot overlaps with a downlink symbol indicated by the cell-specific TDD UL/DL configuration. Alternatively, the UE 205 may receive a DL transmission from the RAN node 210 in a second set of (one or more) symbols of the slot, where at least one symbol of the second set of symbols of the slot overlaps with an uplink symbol indicated by the cell-specific TDD UL/DL configuration.

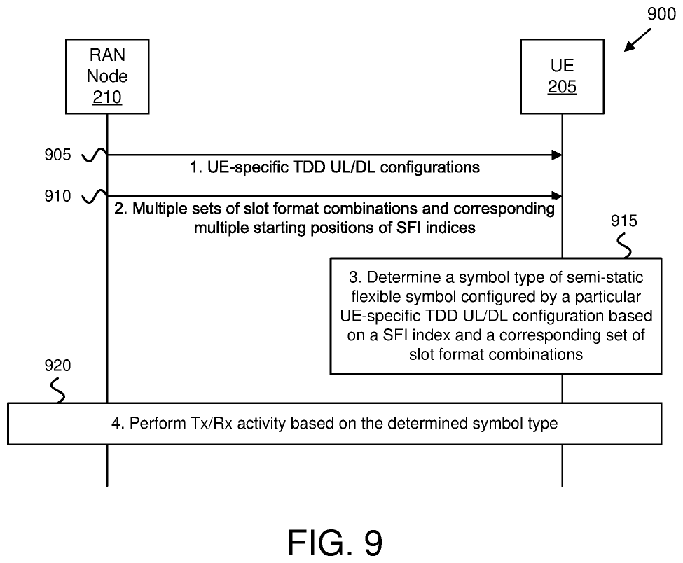

FIG. 9 depicts call flow of an exemplary procedure 900 for performing transmission/reception (“Tx/Rx”) based on a UE-specific (i.e., dedicated) TDD UL/DL configuration, according to embodiments of the disclosure. The procedure 900 involves the UE 205 (e.g., one embodiment of the remote unit 105) and the RAN node 210 (e.g., a gNB or an embodiment of the base unit 121) which provides a serving cell.

At Step 1, the RAN node 210 transmits multiple UE-specific (i.e., dedicated) TDD UL/DL configurations to the UE 205 (see messaging 905). The details and contents of the UE-specific TDD UL/DL configurations are according to the embodiments described herein.

At Step 2, the RAN node 210 transmits multiple sets of slot format combinations and corresponding multiple starting positions of SFI indices (see messaging 910), where each set of slot format combinations and a corresponding starting position of SFI index are associated with each UE-specific TDD UL/DL configuration.

At Step 3, the UE 205 determines a symbol type of a flexible symbol semi-statically configured by a particular UE-specific TDD UL/DL configuration based on a SFI index and a corresponding set of slot format combinations (see block 915).

At Step 4, the RAN node 210 and UE 205 perform Tx/Rx activity based on the determined symbol type (see block 920). In particular, the UE 205 may transmit a UL transmission to the RAN node 210 in a first set of (one or more) symbols of a slot, where at least one symbol of the first set of symbols of the slot overlaps with a downlink symbol indicated by the cell-specific TDD UL/DL configuration. Alternatively, the UE 205 may receive a DL transmission from the RAN node 210 in a second set of (one or more) symbols of the slot, where at least one symbol of the second set of symbols of the slot overlaps with an uplink symbol indicated by the cell-specific TDD UL/DL configuration.

TDD systems are prone to various cases of interference among communications. In addition to remote interference due to atmospheric phenomena that may affect both static-TDD and dynamic-TDD systems, dynamic TDD is particularly prone to cross-link interference (“CLI”), inter-cell interference (“ICI”), and the like. Existing methods to control or mitigate interference include inter-cell coordination, interference measurement and reporting, etc., followed by appropriate actions such as link adaptation, beamforming, and so on.

In the existing NR systems, information elements (“IEs”) may be communicated over an Xn interface from a first gNB to a second gNB that informs the second gNB of the “intended” TDD UL/DL configuration at the first gNB. Then, the second gNB may use the information to control or mitigate interference at slots/symbols that may experience different UL/DL “directions” in two cells in a vicinity.

According to embodiments of a second solution, the following techniques may be applied in various embodiments and implementations of the present disclosure.

In some embodiments, a first gNB may send to a second gNB an Xn IE comprising information of which symbols may be overridden by each, any, or all the parameters in the list of TDD UL/DL configurations, e.g., tdd-UL-DL-ConfigurationDedicatedList-r18.

For example, a new IE called IntendedTDD-DL-ULConfiguration-NR-Override-r18, sent from the first gNB to the second gNB over an Xn interface, may comprise a plurality of parameters, wherein each parameter is associated with a slot or symbol in a TDD configuration. Each of the parameters may take one of two values.

A first value indicates to the second gNB that the associated slot or symbol may not be overridden by a list of TDD UL/DL configuration with respect to a reference TDD UL/DL configuration at the first gNB and/or a gNB (or other network node) in the vicinity of the first gNB.

A second value may indicate to the second gNB that the associated symbol or slot may be overridden by a list of TDD UL/DL configuration with respect to a reference TDD UL/DL configuration at the first gNB and/or a gNB (or other network node) in the vicinity of the first gNB.

In one embodiment, the new IE may provide the said information only with respect to the first gNB.

In an alternative embodiment, the new IE may provide the said information with respect to any one or multiple network nodes in a vicinity of the first gNB. This embodiment may aim at controlling the overhead and/or complexity of the Xn signaling among gNBs and/or other network nodes. In one example, the first gNB may be a wide-area base-station, whereas the network nodes in its vicinity are medium-range or local-area base-stations. In another example, the first gNB may be a medium-range base-station, whereas the network nodes in its vicinity are local-area base-stations.

In yet another example, the first gNB is a fixed based station, whereas the network nodes in its vicinity may be other types of network nodes such as mobile base-stations, mobile relays such as vehicle-mounted relays (“VMRs”), Integrated Access and Backhaul (“IAB”) nodes, and the like. In yet another example, the first gNB may be an IAB donor, whereas the network nodes in its vicinity are IAB nodes configured by the IAB donor.

In some examples, the first gNB receives a first plurality of IEs with a format such as IntendedTDD-DL-ULConfiguration-NR-Override-r18 from one or multiple network nodes in its vicinity, wherein each IE comprises parameters, each parameter associated with a slot or symbol, wherein each parameter indicates to the first gNB whether the associated slot or symbol may be overridden by a list of TDD UL/DL configurations with respect to a reference TDD UL/DL configuration at a network node in a vicinity. Then, the first gNB may send a second IE with format IntendedTDD-DL-ULConfiguration-NR-Override-r18 to the second gNB, wherein each parameter in the second IE indicates to the second gNB whether an associated slot or symbol may be overridden by any or some of the network nodes in the vicinity as indicated by one or multiple of the IEs in the first plurality of IEs.

In those examples, in order to avoid propagating UL/DL overriding information to an indefinite number of hops, the information in the IEs may be marked by a number of hops, or alternatively, different IE formats or different parameters in the IEs may be used in the first plurality of IEs versus the second IE. In one example, a new IE called IntendedTDD-DL-ULConfiguration-NR-NeighborsOverride-r18, sent by the first gNB to the second gNB, may comprise parameters computed based on the said information in IntendedTDD-DL-ULConfiguration-NR-Override-r18 IEs from network nodes in the vicinity.

In another example, the IntendedTDD-DL-ULConfiguration-NR-Override-r18 IE comprises two sets of parameters, one set associated with a configuration in the first gNB and another set associated with the information collected from network nodes in the vicinity. Alternatively, instead of new IEs, the existing IE IntendedTDD-DL-ULConfiguration-NR may comprise the said parameters in the various examples.

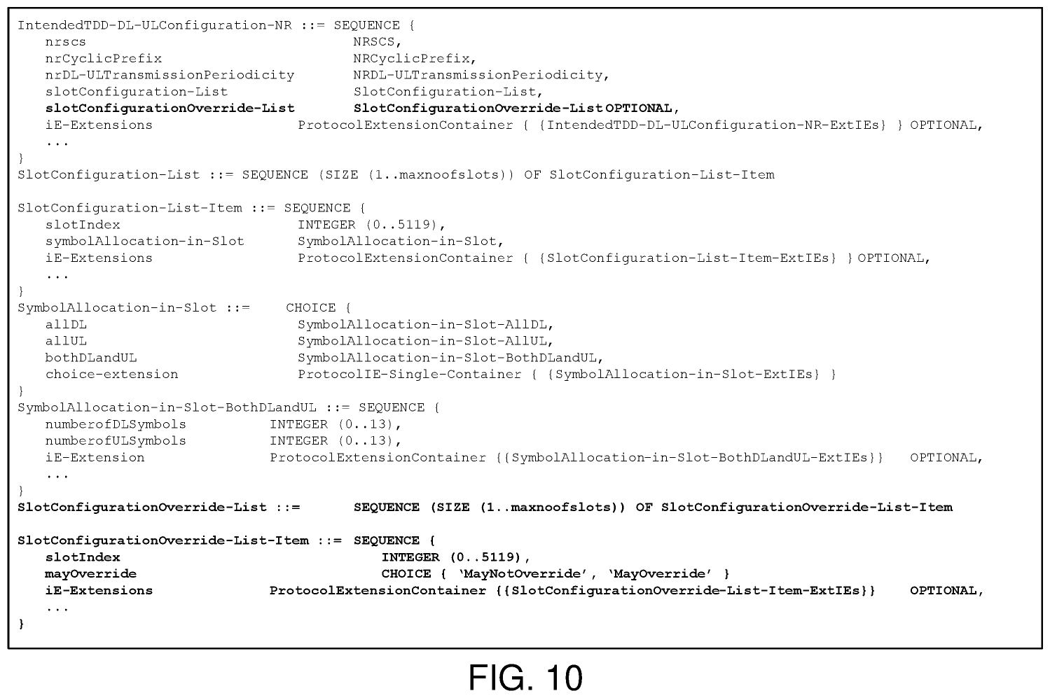

FIG. 10 depicts an example of an ASN.1 code for XnAP signaling for mitigating interference, according to embodiments of the disclosure. In this example, the new optional parameter slotConfigurationOverride-List provides a list of values from {‘MayNotOverride,’ ‘MayOverride’}, each value associated with a slot indicated by the parameter slotIndex in SlotConfigurationOverride-List-Item. Then, if a slot is marked as “may override,” the second gNB may assume that a TDD UL/DL direction of any or all the symbols in the slot may be overridden at the first gNB and/or, in some examples, at a network node in a vicinity of the first gNB. An optional parameter may be introduced similarly for association with individual symbols in a slot instead of a whole slot.

In some embodiments, in an IAB system, the IEs may be communicated over an F1 interface instead of an Xn interface. Each of a first TRP transmitting an IE and a second TRP receiving the IE may be an IAB donor or an IAB node configured by the IAB donor.

In some embodiments, the terms antenna, panel, and antenna panel are used interchangeably. An antenna panel may be a hardware that is used for transmitting and/or receiving radio signals at frequencies lower than 6 GHz, e.g., frequency range 1 (“FR1”), or higher than 6 GHZ, e.g., frequency range 2 (“FR2”) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or multiple spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices such as a CU, it can be used for signaling or local decision making.

In some embodiments, an antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on implementation, a “panel” can have at least one of the following functionalities as an operational role of Unit of antenna group to control its Tx beam independently, Unit of antenna group to control its transmission power independently, Unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or comprise a duration of time over which the network entity assumes there will be no change to the mapping. Device may report its capability with respect to the “panel” to the network entity. The device capability may include at least the number of “panels.” In one implementation, the device may support transmission from one beam within a panel; with multiple panels, more than one beam (one beam per panel) may be used for transmission. In another implementation, more than one beam per panel may be supported/used for transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial reception (“Rx”) parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission, i.e., the device would need to form beams for directional transmission. A QCL-TypeD between two reference signals A and B, the reference signal A is considered to be spatially co-located with reference signal B and the device may assume that the reference signals A and B can be received with the same spatial filter (e.g., with the same Rx beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (device assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

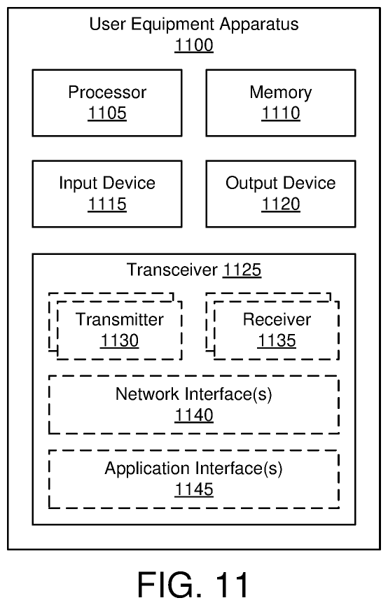

FIG. 11 depicts a user equipment apparatus 1100 that may be used for UE-specific TDD UL/DL configurations for full-duplex operation, according to embodiments of the disclosure. In various embodiments, the user equipment apparatus 1100 is used to implement one or more of the solutions described above. The user equipment apparatus 1100 may be one embodiment of a user endpoint, such as the remote unit 105 and/or the UE 205, as described above. Furthermore, the user equipment apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the user equipment apparatus 1100 may not include any input device 1115 and/or output device 1120. In various embodiments, the user equipment apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. In some embodiments, the transceiver 1125 communicates with one or more cells (or wireless coverage areas) supported by one or more base units 121. In various embodiments, the transceiver 1125 is operable on unlicensed spectrum. Moreover, the transceiver 1125 may include multiple UE panels supporting one or more beams. Additionally, the transceiver 1125 may support at least one network interface 1140 and/or application interface 1145. The application interface(s) 1145 may support one or more APIs. The network interface(s) 1140 may support 3GPP reference points, such as Uu, N1, PC5, etc. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125.

In various embodiments, the processor 1105 controls the user equipment apparatus 1100 to implement the above-described UE behaviors. In certain embodiments, the processor 1105 may include an application processor (also known as “main processor”) which manages application-domain and operating system (“OS”) functions and a baseband processor (also known as “baseband radio processor”) which manages radio functions.

In various embodiments, via the transceiver 1125, the processor 1105 receives information of a cell-specific TDD UL/DL configuration and receives information of a plurality of UE-specific (i.e., dedicated) TDD UL/DL configurations, where each of the plurality of UE-specific TDD UL/DL configurations is associated with particular spatial information. Additionally, via the transceiver 1125, the processor 1105 performs communication activity based on the plurality of UE-specific TDD UL/DL configurations. Here, the communication activity may include: 1) transmission in a first set of (one or more) symbols of a slot, where at least one symbol of the first set of symbols of the slot overlaps with a downlink symbol indicated by the cell-specific TDD UL/DL configuration; and/or 2) reception in a second set of (one or more) symbols of the slot, where at least one symbol of the second set of symbols of the slot overlaps with an uplink symbol indicated by the cell-specific TDD UL/DL configuration.

In some embodiments, the transmission in the first set of symbols of the slot is based on first spatial information associated with a first UE-specific TDD UL/DL configuration of the plurality of UE-specific TDD UL/DL configurations. In some embodiments, the reception in the second set of symbols of the slot is based on second spatial information associated with a second UE-specific TDD UL/DL configuration of the plurality of UE-specific TDD UL/DL configurations.

In some embodiments, the particular spatial information includes at least one of: A) a downlink (i.e., PDSCH) TCI state, B) an uplink TCI state, C) a joint downlink/uplink TCI state, D) a CORESET Pool Index value (i.e., coresetPoolIndex value), E) an SRS resource set, F) a SpatialRelationInfoPoolIndex value (e.g., pucch-SpatialRelationInfoPoolIndex value or srs-SpatialRelationInfoPoolIndex value), G) a QCL Type-D indication, or a combination thereof.

In some embodiments, the processor 1105 controls the transceiver 1125 to: A) receive a reference UE-specific TDD UL/DL configuration; B) perform, based on the reference UE-specific TDD UL/DL configuration, at least one activity selected from: 1) transmission of a semi-statically configured uplink channel (or signal); or 2) reception of a semi-statically configured downlink channel (or signal).

In certain embodiments, transmission of the semi-statically configured uplink channel (or signal) and reception of the semi-statically configured downlink channel (or signal) are performed based on the cell-specific TDD UL/DL configuration and the reference UE-specific TDD UL/DL configuration. In further embodiments, the reference UE-specific TDD UL/DL configuration overrides only symbols configured as ‘flexible’ by the cell-specific TDD UL/DL configuration.

In certain embodiments, the processor 1105 controls the transceiver 1125 to: A) receive dynamic scheduling information for a channel (or signal); B) determine a UE-specific TDD UL/DL configuration associated with a spatial information of the dynamically scheduled channel (or signal); and C) perform, based on the UE-specific TDD UL/DL configuration, 1) transmission of the dynamically scheduled channel (or signal), or 2) reception of the dynamically scheduled channel (or signal).

In some embodiments, the processor 1105 controls the transceiver 1125 to: A) receive information associating a subset of DL reference signals with each of the plurality of UE-specific TDD UL/DL configurations; B) receive a spatial information for a scheduled channel (or signal), where the spatial information includes an indication of a DL reference signal; and C) identify a symbol type for symbols allocated for the scheduled channel (or signal) based on a particular UE-specific TDD UL/DL configuration associated with the indicated DL reference signal.

In some embodiments, the processor 1105 controls the transceiver 1125 to: A) receive information associating a subset of SRS with each of the plurality of UE-specific TDD UL/DL configurations; B) receive a spatial information for a scheduled channel (or signal), where the spatial information includes an indication of an SRS resource; and C) identify a symbol type for symbols allocated for the scheduled channel (or signal) based on a particular UE-specific TDD UL/DL configuration associated with the indicated SRS resource.

In various embodiments, via the transceiver 1125, the processor 1105 receives information of a plurality of UE-specific (i.e., dedicated) TDD UL/DL configurations, where each of the plurality of UE-specific TDD UL/DL configurations is associated with particular spatial information (e.g., TCI state, coresetPoolIndex value, SRS resource set, pucch-SpatialRelationInfoPoolIndex value, srs-SpatialRelationInfoPoolIndex value, etc.). Via the transceiver 1125, the processor 1105 receives multiple sets of slot format combinations and corresponding multiple starting positions of SFI indices, each set of slot format combinations and corresponding starting position of SFI index associated with each UE-specific TDD UL/DL configuration. Moreover, the processor 1105 dynamically determines a symbol type of a semi-static flexible symbol configured by a particular UE-specific TDD UL/DL configuration based on a SFI index and a corresponding set of slot format combinations.

In some embodiments, the processor 1105 controls the transceiver 1125 to perform communication activity based on the determines symbol type. Here, the communication activity includes: A) transmission in a first set of (one or more) symbols of a slot, where at least one symbol of the first set of symbols of the slot overlaps with the semi-static flexible symbol, when the semi-static flexible symbol is determined as an uplink symbol; or B) reception in a second set of (one or more) symbols of the slot, where at least one symbol of the second set of symbols of the slot overlaps with the semi-static flexible symbol, when the semi-static flexible symbol is determined as a downlink symbol.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to UE-specific TDD UL/DL configurations for full-duplex operation. For example, the memory 1110 may store parameters, configurations, and the like as described above. In certain embodiments, the memory 1110 also stores program code and related data, such as an operating system or other controller algorithms operating on the user equipment apparatus 1100.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 1120 may include a wearable display separate from, but communicatively coupled to, the rest of the user equipment apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 communicates with one or more network functions of a mobile communication network via one or more access networks. The transceiver 1125 operates under the control of the processor 1105 to transmit messages, data, and other signals and also to receive messages, data, and other signals. For example, the processor 1105 may selectively activate the transceiver 1125 (or portions thereof) at particular times in order to send and receive messages.

The transceiver 1125 includes at least one transmitter 1130 and at least one receiver 1135. One or more transmitters 1130 may be used to provide UL communication signals to a base unit 111, such as the UL transmissions described herein. Similarly, one or more receivers 1135 may be used to receive DL communication signals from the base unit 111, as described herein. Although only one transmitter 1130 and one receiver 1135 are illustrated, the user equipment apparatus 1100 may have any suitable number of transmitters 1130 and receivers 1135. Further, the transmitter(s) 1130 and the receiver(s) 1135 may be any suitable type of transmitters and receivers. In one embodiment, the transceiver 1125 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 1125, transmitters 1130, and receivers 1135 may be implemented as physically separate components that access a shared hardware resource and/or software resource, such as for example, the network interface 1140.

In various embodiments, one or more transmitters 1130 and/or one or more receivers 1135 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 1130 and/or one or more receivers 1135 may be implemented and/or integrated into a multi-chip module.

In some embodiments, other components such as the network interface 1140 or other hardware components/circuits may be integrated with any number of transmitters 1130 and/or receivers 1135 into a single chip. In such embodiment, the transmitters 1130 and receivers 1135 may be logically configured as a transceiver 1125 that uses one or more common control signals or as modular transmitters 1130 and receivers 1135 implemented in the same hardware chip or in a multi-chip module.

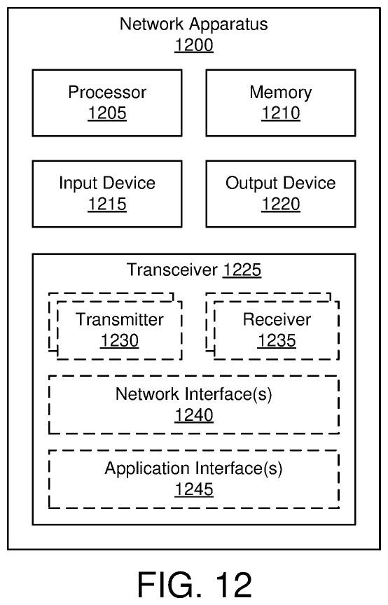

FIG. 12 depicts a network apparatus 1200 that may be used for UE-specific TDD UL/DL configurations for full-duplex operation, according to embodiments of the disclosure. In one embodiment, the network apparatus 1200 may be one implementation of a network endpoint, such as the base unit 121 and/or RAN node 210, as described above. Furthermore, the network apparatus 1200 may include a processor 1205, a memory 1210, an input device 1215, an output device 1220, and a transceiver 1225.

In some embodiments, the input device 1215 and the output device 1220 are combined into a single device, such as a touchscreen. In certain embodiments, the network apparatus 1200 may not include any input device 1215 and/or output device 1220. In various embodiments, the network apparatus 1200 may include one or more of: the processor 1205, the memory 1210, and the transceiver 1225, and may not include the input device 1215 and/or the output device 1220.

As depicted, the transceiver 1225 includes at least one transmitter 1230 and at least one receiver 1235. Here, the transceiver 1225 communicates with one or more remote units 105. Additionally, the transceiver 1225 may support at least one network interface 1240 and/or application interface 1245. The application interface(s) 1245 may support one or more APIs. The network interface(s) 1240 may support 3GPP reference points, such as Uu, N1, N2 and N3. Other network interfaces 1240 may be supported, as understood by one of ordinary skill in the art.

The processor 1205, in one embodiment, may include any known controller capable of executing computer-readable instructions and/or capable of performing logical operations. For example, the processor 1205 may be a microcontroller, a microprocessor, a CPU, a GPU, an auxiliary processing unit, a FPGA, or similar programmable controller. In some embodiments, the processor 1205 executes instructions stored in the memory 1210 to perform the methods and routines described herein. The processor 1205 is communicatively coupled to the memory 1210, the input device 1215, the output device 1220, and the transceiver 1225.

In various embodiments, the network apparatus 1200 is a RAN node (e.g., gNB) that communicates with one or more UEs, as described herein. In such embodiments, the processor 1205 controls the network apparatus 1200 to perform the above-described RAN behaviors. When operating as a RAN node, the processor 1205 may include an application processor (also known as “main processor”) which manages application-domain and operating system (“OS”) functions and a baseband processor (also known as “baseband radio processor”) which manages radio functions.

In various embodiments, via the transceiver 1225, the processor 1205 transmits information of a cell-specific TDD UL/DL configuration of a first cell and transmits information of a plurality of UE-specific (i.e., dedicated) TDD UL/DL configurations to at least one UE in the first cell, where each of the plurality of UE-specific TDD UL/DL configurations is associated with particular spatial information. Moreover, via the transceiver 1225, the processor 1205 performs communication activity with the at least one UE based on the plurality of UE-specific TDD UL/DL configurations. Here, the communication activity may include: 1) transmission in a first set of (one or more) symbols of a slot, where at least one symbol of the first set of symbols of the slot overlaps with an uplink symbol indicated by the cell-specific TDD UL/DL configuration, and/or 2) reception in a second set of (one or more) symbols of the slot, where at least one symbol of the second set of symbols of the slot overlaps with a downlink symbol indicated by the cell-specific TDD UL/DL configuration.

In some embodiments, the particular spatial information includes at least one of: A) a downlink (i.e., PDSCH) TCI state, B) an uplink TCI state, C) a joint downlink/uplink TCI state, D) a CORESET Pool Index value (i.e., coresetPoolIndex value), E) an SRS resource set, F) a SpatialRelationInfoPoolIndex value (e.g., pucch-SpatialRelationInfoPoolIndex value or srs-Spatial RelationInfoPoolIndex value), G) a QCL Type-D indication, or a combination thereof.

In some embodiments, the processor 1205 controls the transceiver 1225 to: A) send, to a neighboring RAN node, a reference (i.e., intended) TDD UL/DL configuration for the first cell; and B) send, to the neighboring RAN node, override information including a set of parameters indicating whether a respective symbol of the reference TDD UL/DL configuration is permitted to be overridden. In such embodiments, the plurality of UE-specific TDD UL/DL configurations is generated based on the override information. In some embodiments, the override information is sent to multiple neighboring RAN nodes in a vicinity of the network apparatus 1200.

The memory 1210, in one embodiment, is a computer readable storage medium. In some embodiments, the memory 1210 includes volatile computer storage media. For example, the memory 1210 may include a RAM, including DRAM, SDRAM, and/or SRAM. In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data related to UE-specific TDD UL/DL configurations for full-duplex operation. For example, the memory 1210 may store parameters, configurations, and the like, as described above. In certain embodiments, the memory 1210 also stores program code and related data, such as an operating system or other controller algorithms operating on the network apparatus 1200.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, is designed to output visual, audible, and/or haptic signals. In some embodiments, the output device 1220 includes an electronically controllable display or display device capable of outputting visual data to a user. For example, the output device 1220 may include, but is not limited to, an LCD display, an LED display, an OLED display, a projector, or similar display device capable of outputting images, text, or the like to a user. As another, non-limiting, example, the output device 1220 may include a wearable display separate from, but communicatively coupled to, the rest of the network apparatus 1200, such as a smart watch, smart glasses, a heads-up display, or the like. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all or portions of the output device 1220 may be integrated with the input device 1215. For example, the input device 1215 and output device 1220 may form a touchscreen or similar touch-sensitive display. In other embodiments, the output device 1220 may be located near the input device 1215.

The transceiver 1225 includes at least one transmitter 1230 and at least one receiver 1235. One or more transmitters 1230 may be used to communicate with the UE, as described herein. Similarly, one or more receivers 1235 may be used to communicate with network functions in the PLMN and/or RAN, as described herein. Although only one transmitter 1230 and one receiver 1235 are illustrated, the network apparatus 1200 may have any suitable number of transmitters 1230 and receivers 1235. Further, the transmitter(s) 1230 and the receiver(s) 1235 may be any suitable type of transmitters and receivers.

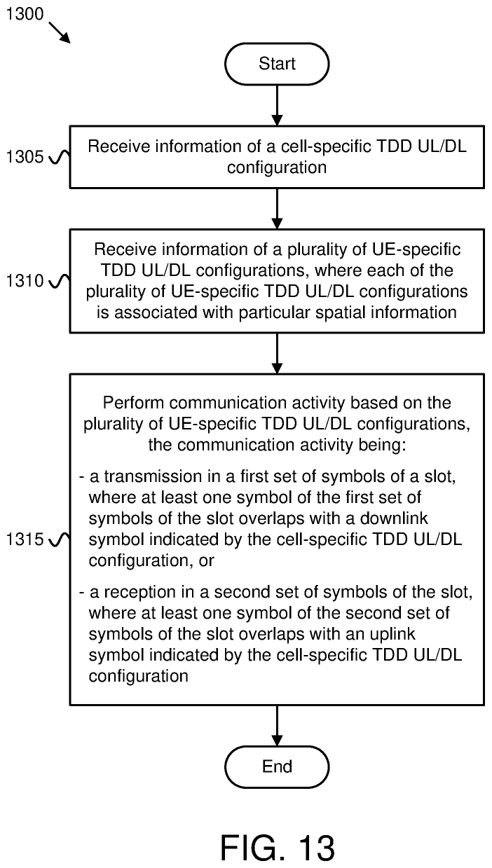

FIG. 13 depicts one embodiment of a method 1300 for UE-specific TDD UL/DL configurations for full-duplex operation, according to embodiments of the disclosure. In various embodiments, the method 1300 is performed by a communication device, such as a remote unit 105, a UE 205, and/or the user equipment apparatus 1100, as described above. In some embodiments, the method 1300 is performed by a processor, such as a microcontroller, a microprocessor, a CPU, a GPU, an auxiliary processing unit, a FPGA, or the like.

The method 1300 includes receiving 1305 information of a cell-specific TDD UL/DL configuration. The method 1300 includes receiving 1310 information of a plurality of UE-specific TDD UL/DL configurations, where each of the plurality of UE-specific TDD UL/DL configurations is associated with particular spatial information. The method 1300 includes performing 1315 communication activity based on the plurality of UE-specific TDD UL/DL configurations. Here, the communication activity is a transmission in a first set of symbols of a slot, where at least one symbol of the first set of symbols of the slot overlaps with a downlink symbol indicated by the cell-specific TDD UL/DL configuration, or a reception in a second set of symbols of the slot, where at least one symbol of the second set of symbols of the slot overlaps with an uplink symbol indicated by the cell-specific TDD UL/DL configuration. The method 1300 ends.

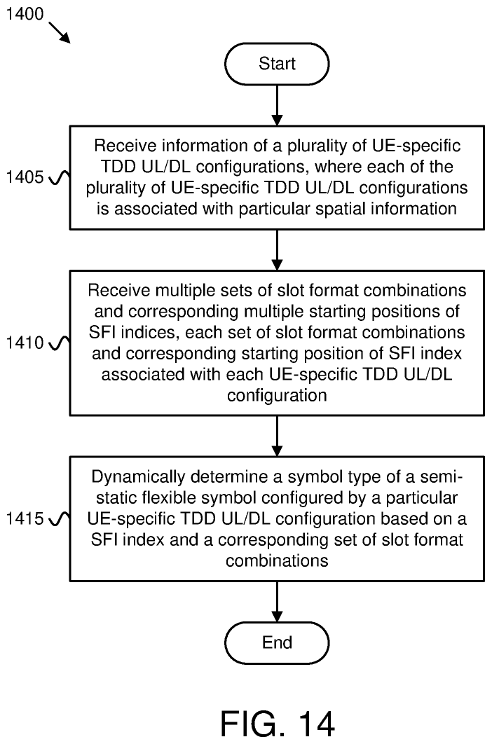

FIG. 14 depicts one embodiment of a method 1400 for UE-specific TDD UL/DL configurations for full-duplex operation, according to embodiments of the disclosure. In various embodiments, the method 1400 is performed by a communication device, such as a remote unit 105, a UE 205, and/or the user equipment apparatus 1100, as described above. In some embodiments, the method 1400 is performed by a processor, such as a microcontroller, a microprocessor, a CPU, a GPU, an auxiliary processing unit, a FPGA, or the like.

The method 1400 includes receiving 1405 information of a plurality of UE-specific TDD UL/DL configurations, where each of the plurality of UE-specific TDD UL/DL configurations is associated with particular spatial information. The method 1400 includes receiving 1410 multiple sets of slot format combinations and corresponding multiple starting positions of SFI indices, each set of slot format combinations and corresponding starting position of SFI index associated with each UE-specific TDD UL/DL configuration. The method 1400 includes dynamically determining 1415 a symbol type of a semi-static flexible symbol configured by a particular UE-specific TDD UL/DL configuration based on a SFI index and a corresponding set of slot format combinations. The method 1400 ends.

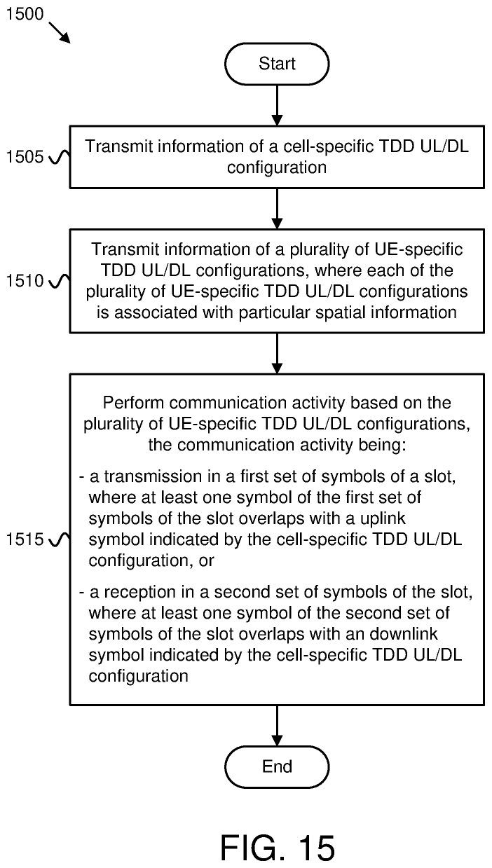

FIG. 15 depicts one embodiment of a method 1500 for UE-specific TDD UL/DL configurations for full-duplex operation, according to embodiments of the disclosure. In various embodiments, the method 1500 is performed by a network device, such as the base unit 121, the RAN node 210, and/or the network apparatus 1200, described above. In some embodiments, the method 1500 is performed by a processor, such as a microcontroller, a microprocessor, a CPU, a GPU, an auxiliary processing unit, a FPGA, or the like.

The method 1500 includes transmitting 1505 information of a cell-specific TDD UL/DL configuration of a first cell. The method 1500 includes transmitting 1510 information of a plurality of UE-specific TDD UL/DL configurations to at least one UE in the first cell, where each of the plurality of UE-specific TDD UL/DL configurations is associated with particular spatial information. The method 1500 includes performing 1515 communication activity with the at least one UE based on the plurality of UE-specific TDD UL/DL configurations. Here, the communication activity is a transmission in a first set of symbols of a slot, where at least one symbol of the first set of symbols of the slot overlaps with an uplink symbol indicated by the cell-specific TDD UL/DL configuration, or a reception in a second set of symbols of the slot, where at least one symbol of the second set of symbols of the slot overlaps with a downlink symbol indicated by the cell-specific TDD UL/DL configuration. The method 1500 ends.

Disclosed herein is a first apparatus for UE-specific TDD UL/DL configurations for full-duplex operation, according to embodiments of the disclosure. The first apparatus may be implemented by a communication device, such as a remote unit 105, a UE 205, and/or the user equipment apparatus 1100, as described above. The first apparatus includes a processor coupled to a memory, the processor configured to cause the first apparatus to: A) receive information of a cell-specific TDD UL/DL configuration; B) receive information of a plurality of UE-specific (i.e., dedicated) TDD UL/DL configurations, where each of the plurality of UE-specific TDD UL/DL configurations is associated with particular spatial information; and C) perform communication activity based on the plurality of UE-specific TDD UL/DL configurations, the communication activity including: 1) transmission in a first set of symbols of a slot, where at least one symbol of the first set of symbols of the slot overlaps with a downlink symbol indicated by the cell-specific TDD UL/DL configuration; or 2) reception in a second set of symbols of the slot, where at least one symbol of the second set of symbols of the slot overlaps with an uplink symbol indicated by the cell-specific TDD UL/DL configuration.

In some embodiments, the transmission in the first set of symbols of the slot is based on first spatial information associated with a first UE-specific TDD UL/DL configuration of the plurality of UE-specific TDD UL/DL configurations. In some embodiments, the reception in the second set of symbols of the slot is based on second spatial information associated with a second UE-specific TDD UL/DL configuration of the plurality of UE-specific TDD UL/DL configurations.

In some embodiments, the particular spatial information includes at least one of: A) a downlink (i.e., PDSCH) TCI state, B) an uplink TCI state, C) a joint downlink/uplink TCI state, D) a CORESET Pool Index value (i.e., coresetPoolIndex value), E) an SRS resource set, F) a SpatialRelationInfoPoolIndex value (e.g., pucch-SpatialRelationInfoPoolIndex value or srs-Spatial RelationInfoPoolIndex value), G) a QCL Type-D indication, or a combination thereof.

In some embodiments, the processor is further configured to cause the first apparatus to: A) receive a reference UE-specific TDD UL/DL configuration; B) perform, based on the reference UE-specific TDD UL/DL configuration, at least one activity selected from: 1) transmission of a semi-statically configured uplink channel (or signal); or 2) reception of a semi-statically configured downlink channel (or signal).

In certain embodiments, transmission of the semi-statically configured uplink channel (or signal) and reception of the semi-statically configured downlink channel (or signal) are performed based on the cell-specific TDD UL/DL configuration and the reference UE-specific TDD UL/DL configuration. In further embodiments, the reference UE-specific TDD UL/DL configuration overrides only symbols configured as ‘flexible’ by the cell-specific TDD UL/DL configuration.

In certain embodiments, the processor is further configured to cause the first apparatus to: A) receive dynamic scheduling information for a channel (or signal); B) determine a UE-specific TDD UL/DL configuration associated with a spatial information of the dynamically scheduled channel (or signal); and C) perform, based on the UE-specific TDD UL/DL configuration, 1) transmission of the dynamically scheduled channel (or signal), or 2) reception of the dynamically scheduled channel (or signal).

In some embodiments, the processor is configured to cause the first apparatus to: A) receive information associating a subset of DL reference signals with each of the plurality of UE-specific TDD UL/DL configurations; B) receive a spatial information for a scheduled channel (or signal), where the spatial information includes an indication of a DL reference signal; and C) identify a symbol type for symbols allocated for the scheduled channel (or signal) based on a particular UE-specific TDD UL/DL configuration associated with the indicated DL reference signal.

In some embodiments, the processor is configured to cause the first apparatus to: A) receive information associating a subset of SRS with each of the plurality of UE-specific TDD UL/DL configurations; B) receive a spatial information for a scheduled channel (or signal), where the spatial information includes an indication of an SRS resource; and C) identify a symbol type for symbols allocated for the scheduled channel (or signal) based on a particular UE-specific TDD UL/DL configuration associated with the indicated SRS resource.

Disclosed herein is a first method for UE-specific TDD UL/DL configurations for full-duplex operation, according to embodiments of the disclosure. The first method may be performed by a communication device, such as a remote unit 105, a UE 205, and/or the user equipment apparatus 1100, as described above. The first method includes receiving information of a cell-specific TDD UL/DL configuration and receiving information of a plurality of UE-specific (i.e., dedicated) TDD UL/DL configurations, where each of the plurality of UE-specific TDD UL/DL configurations is associated with particular spatial information. The first method includes performing communication activity based on the plurality of UE-specific TDD UL/DL configurations, the communication activity including: 1) transmission in a first set of symbols of a slot, where at least one symbol of the first set of symbols of the slot overlaps with a downlink symbol indicated by the cell-specific TDD UL/DL configuration; or 2) reception in a second set of symbols of the slot, where at least one symbol of the second set of symbols of the slot overlaps with an uplink symbol indicated by the cell-specific TDD UL/DL configuration.

In some embodiments, the transmission in the first set of symbols of the slot is based on first spatial information associated with a first UE-specific TDD UL/DL configuration of the plurality of UE-specific TDD UL/DL configurations. In some embodiments, the reception in the second set of symbols of the slot is based on second spatial information associated with a second UE-specific TDD UL/DL configuration of the plurality of UE-specific TDD UL/DL configurations.

In some embodiments, the particular spatial information includes at least one of: A) a downlink (i.e., PDSCH) TCI state, B) an uplink TCI state, C) a joint downlink/uplink TCI state, D) a CORESET Pool Index value (i.e., coresetPoolIndex value), E) an SRS resource set, F) a SpatialRelationInfoPoolIndex value (e.g., pucch-SpatialRelationInfoPoolIndex value or srs-Spatial RelationInfoPoolIndex value), G) a QCL Type-D indication, or a combination thereof.

In some embodiments, the first method further includes receiving a reference UE-specific TDD UL/DL configuration and performing, based on the reference UE-specific TDD UL/DL configuration, at least one activity selected from: 1) transmission of a semi-statically configured uplink channel (or signal); or 2) reception of a semi-statically configured downlink channel (or signal).

In certain embodiments, transmission of the semi-statically configured uplink channel (or signal) and reception of the semi-statically configured downlink channel (or signal) are performed based on the cell-specific TDD UL/DL configuration and the reference UE-specific TDD UL/DL configuration. In further embodiments, the reference UE-specific TDD UL/DL configuration overrides only symbols configured as ‘flexible’ by the cell-specific TDD UL/DL configuration.

In certain embodiments, the first method further includes receiving dynamic scheduling information for a channel (or signal) and determining a UE-specific TDD UL/DL configuration associated with a spatial information of the dynamically scheduled channel (or signal). In such embodiments, the first method additionally includes performing transmission or reception of the dynamically scheduled channel (or signal), based on the UE-specific TDD UL/DL configuration.

In some embodiments, the first method includes receiving information associating a subset of DL reference signals with each of the plurality of UE-specific TDD UL/DL configurations and receiving a spatial information for a scheduled channel (or signal), where the spatial information includes an indication of a DL reference signal. In such embodiments, the first method further includes identifying a symbol type for symbols allocated for the scheduled channel (or signal) based on a particular UE-specific TDD UL/DL configuration associated with the indicated DL reference signal.

In some embodiments, the first method includes receiving information associating a subset of SRS with each of the plurality of UE-specific TDD UL/DL configurations and receiving a spatial information for a scheduled channel (or signal), where the spatial information includes an indication of an SRS resource. In such embodiments, the first method further includes identifying a symbol type for symbols allocated for the scheduled channel (or signal) based on a particular UE-specific TDD UL/DL configuration associated with the indicated SRS resource.

Disclosed herein is a second apparatus for UE-specific TDD UL/DL configurations for full-duplex operation, according to embodiments of the disclosure. The second apparatus may be implemented by a communication device, such as a remote unit 105, a UE 205, and/or the user equipment apparatus 1100, as described above. The second apparatus includes a processor coupled to a memory, the processor configured to cause the second apparatus to: A) receive information of a plurality of UE-specific (i.e., dedicated) TDD UL/DL configurations, where each of the plurality of UE-specific TDD UL/DL configurations is associated with particular spatial information (e.g., TCI state, coresetPoolIndex value, SRS resource set, pucch-SpatialRelationInfoPoolIndex value, srs-SpatialRelationInfoPoolIndex value, etc.); B) receive multiple sets of slot format combinations and corresponding multiple starting positions of SFI indices, each set of slot format combinations and corresponding starting position of SFI index associated with each UE-specific TDD UL/DL configuration; and C) dynamically determine a symbol type of a semi-static flexible symbol configured by a particular UE-specific TDD UL/DL configuration based on a SFI index and a corresponding set of slot format combinations.

In some embodiments, the processor is further configured to cause the second apparatus to perform communication activity based on the determines symbol type, the communication activity including: A) transmission in a first set of symbols of a slot, where at least one symbol of the first set of symbols of the slot overlaps with the semi-static flexible symbol, when the semi-static flexible symbol is determined as an uplink symbol; or B) reception in a second set of symbols of the slot, where at least one symbol of the second set of symbols of the slot overlaps with the semi-static flexible symbol, when the semi-static flexible symbol is determined as a downlink symbol.

Disclosed herein is a second method for UE-specific TDD UL/DL configurations for full-duplex operation, according to embodiments of the disclosure. The second method may be performed by a communication device, such as a remote unit 105, a UE 205, and/or the user equipment apparatus 1100, as described above. The second method includes receiving information of a plurality of UE-specific (i.e., dedicated) TDD UL/DL configurations, where each of the plurality of UE-specific TDD UL/DL configurations is associated with particular spatial information (e.g., TCI state, coresetPoolIndex value, SRS resource set, pucch-Spatial RelationInfoPoolIndex value, srs-SpatialRelationInfoPoolIndex value, etc.). The second method includes receiving multiple sets of slot format combinations and corresponding multiple starting positions of SFI indices, each set of slot format combinations and corresponding starting position of SFI index associated with each UE-specific TDD UL/DL configuration. The second method includes dynamically determining a symbol type of a semi-static flexible symbol configured by a particular UE-specific TDD UL/DL configuration based on a SFI index and a corresponding set of slot format combinations.

In some embodiments, the processor is further configured to cause the second apparatus to perform communication activity based on the determines symbol type, the communication activity including: A) transmission in a first set of symbols of a slot, where at least one symbol of the first set of symbols of the slot overlaps with the semi-static flexible symbol, when the semi-static flexible symbol is determined as an uplink symbol; or B) reception in a second set of symbols of the slot, where at least one symbol of the second set of symbols of the slot overlaps with the semi-static flexible symbol, when the semi-static flexible symbol is determined as a downlink symbol.

Disclosed herein is a third apparatus for UE-specific TDD UL/DL configurations for full-duplex operation, according to embodiments of the disclosure. The third apparatus may be implemented by a network device, such as the base unit 121, the RAN node 210, and/or the network apparatus 1200, described above. The third apparatus includes a processor coupled to a memory, the processor configured to cause the third apparatus to: A) transmit information of a cell-specific TDD UL/DL configuration of a first cell; B) transmit information of a plurality of UE-specific (i.e., dedicated) TDD UL/DL configurations to at least one UE in the first cell, where each of the plurality of UE-specific TDD UL/DL configurations is associated with particular spatial information; and C) perform communication activity with the at least one UE based on the plurality of UE-specific TDD UL/DL configurations, the communication activity including: 1) transmission in a first set of symbols of a slot, where at least one symbol of the first set of symbols of the slot overlaps with an uplink symbol indicated by the cell-specific TDD UL/DL configuration; or 2) reception in a second set of symbols of the slot, where at least one symbol of the second set of symbols of the slot overlaps with a downlink symbol indicated by the cell-specific TDD UL/DL configuration.

In some embodiments, the processor is further configured to cause the third apparatus to: A) send, to a neighboring RAN node, a reference (i.e., intended) TDD UL/DL configuration for the first cell; and B) send, to the neighboring RAN node, override information including a set of parameters indicating whether a respective symbol of the reference TDD UL/DL configuration is permitted to be overridden. In such embodiments, the plurality of UE-specific TDD UL/DL configurations is generated based on the override information. In some embodiments, the override information is sent to multiple neighboring RAN nodes in a vicinity of the third apparatus.

Disclosed herein is a third method for UE-specific TDD UL/DL configurations for full-duplex operation, according to embodiments of the disclosure. The third method may be performed by a network device, such as the base unit 121, the RAN node 210, and/or the network apparatus 1200, described above. The third method includes transmitting information of a cell-specific TDD UL/DL configuration of a first cell and transmitting information of a plurality of UE-specific (i.e., dedicated) TDD UL/DL configurations to at least one UE in the first cell, where each of the plurality of UE-specific TDD UL/DL configurations is associated with particular spatial information. The third method includes performing communication activity with the at least one UE based on the plurality of UE-specific TDD UL/DL configurations, the communication activity including: 1) transmission in a first set of symbols of a slot, where at least one symbol of the first set of symbols of the slot overlaps with an uplink symbol indicated by the cell-specific TDD UL/DL configuration; or 2) reception in a second set of symbols of the slot, where at least one symbol of the second set of symbols of the slot overlaps with a downlink symbol indicated by the cell-specific TDD UL/DL configuration.

In some embodiments, the third method includes sending, to a neighboring RAN node, a reference (i.e., intended) TDD UL/DL configuration for the first cell and sending, to the neighboring RAN node, override information including a set of parameters indicating whether a respective symbol of the reference TDD UL/DL configuration is permitted to be overridden. In such embodiments, the plurality of UE-specific TDD UL/DL configurations is generated based on the override information. In some embodiments, the override information is sent to multiple neighboring RAN nodes in a vicinity of the network device.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (“UE”) apparatus comprising:
a processor; and
a memory coupled to the processor, the processor configured to cause the apparatus to:
receive information of a cell-specific Time-Division Duplex (“TDD”) Uplink and Downlink (“UL/DL”) configuration;
receive information of a plurality of UE-specific TDD UL/DL configurations, wherein each of the plurality of UE-specific TDD UL/DL configurations is associated with particular spatial information; and
perform communication activity based on the plurality of UE-specific TDD UL/DL configurations, the communication activity comprising:
transmission in a first set of symbols of a slot, where at least one symbol of the first set of symbols of the slot overlaps with a downlink symbol indicated by the cell-specific TDD UL/DL configuration; or
reception in a second set of symbols of the slot, where at least one symbol of the second set of symbols of the slot overlaps with an uplink symbol indicated by the cell-specific TDD UL/DL configuration.

2. The apparatus of claim 1, wherein the transmission in the first set of symbols of the slot is based on first spatial information associated with a first UE-specific TDD UL/DL configuration of the plurality of UE-specific TDD UL/DL configurations.

3. The apparatus of claim 1, wherein the reception in the second set of symbols of the slot is based on second spatial information associated with a second UE-specific TDD UL/DL configuration of the plurality of UE-specific TDD UL/DL configurations.

4. The apparatus of claim 1, wherein the particular spatial information comprises at least one of:
a downlink Transmit Configuration Indicator (“TCI”) state, an uplink TCI state,
a joint downlink/uplink TCI state,
a Control Resource Set Pool Index value,
a Sounding Reference Signal (“SRS”) resource set,
a SpatialRelationInfoPoolIndex value,
a Quasi-Co-Location Type-D indication,
or a combination thereof.

5. The apparatus of claim 1, wherein the processor is further configured to cause the apparatus to:
receive a reference UE-specific TDD UL/DL configuration;
perform, based on the reference UE-specific TDD UL/DL configuration, at least one activity selected from:
transmission of a semi-statically configured uplink channel; or
reception of a semi-statically configured downlink channel.

6. The apparatus of claim 5, wherein the processor is further configured to cause the apparatus to:
receive dynamic scheduling information for a channel;
determine a UE-specific TDD UL/DL configuration associated with a spatial information of the dynamically scheduled channel; and
perform, based on the UE-specific TDD UL/DL configuration, transmission, or reception of the dynamically scheduled channel.

7. The apparatus of claim 5, wherein transmission of the semi-statically configured uplink channel and reception of the semi-statically configured downlink channel are performed based on the cell-specific TDD UL/DL configuration and the reference UE-specific TDD UL/DL configuration.

8. The apparatus of claim 7, wherein the reference UE-specific TDD UL/DL configuration overrides only symbols configured as ‘flexible’ by the cell-specific TDD UL/DL configuration.

9. The apparatus of claim 1, wherein the processor is further configured to cause the apparatus to:
receive information associating a subset of downlink (“DL”) reference signals with each of the plurality of UE-specific TDD UL/DL configurations;
receive a spatial information for a scheduled channel, wherein the spatial information comprises an indication of a DL reference signal; and
identify a symbol type for symbols allocated for the scheduled channel based on a particular UE-specific TDD UL/DL configuration associated with the indicated DL reference signal.

10. The apparatus of claim 1, wherein the processor is further configured to cause the apparatus to:
receive information associating a subset of sounding reference signals (“SRS”) with each of the plurality of UE-specific TDD UL/DL configurations;
receive a spatial information for a scheduled channel, wherein the spatial information comprises an indication of an SRS resource; and
identify a symbol type for symbols allocated for the scheduled channel based on a particular UE-specific TDD UL/DL configuration associated with the indicated SRS resource.

11. A User Equipment (“UE”) apparatus comprising:
a processor; and
a memory coupled to the processor, the processor configured to cause the apparatus to:
receive information of a plurality of UE-specific Time-Division Duplex (“TDD”) Uplink and Downlink (“UL/DL”) configurations, wherein each of the plurality of UE-specific TDD UL/DL configurations is associated with particular spatial information;
receive multiple sets of slot format combinations and corresponding multiple starting positions of Slot Format Indicator (“SFI”) indices, each set of slot format combinations and corresponding starting position of SFI index associated with each UE-specific TDD UL/DL configuration; and
dynamically determine a symbol type of a semi-static flexible symbol configured by a particular UE-specific TDD UL/DL configuration based on a SFI index and a corresponding set of slot format combinations.

12. The apparatus of claim 11, wherein the processor is further configured to cause the apparatus to perform communication activity based on the determines symbol type, the communication activity comprising:
transmission in a first set of symbols of a slot, where at least one symbol of the first set of symbols of the slot overlaps with the semi-static flexible symbol, when the semi-static flexible symbol is determined as an uplink symbol; or
reception in a second set of symbols of the slot, where at least one symbol of the second set of symbols of the slot overlaps with the semi-static flexible symbol, when the semi-static flexible symbol is determined as a downlink symbol.

13. A first radio access network (“RAN”) apparatus comprising:
a processor; and
a memory coupled to the processor, the processor configured to cause the apparatus to:
transmit information of a cell-specific Time-Division Duplex (“TDD”) Uplink and Downlink (“UL/DL”) configuration of a first cell;
transmit information of a plurality of UE-specific TDD UL/DL configurations to at least one UE in the first cell, wherein each of the plurality of UE-specific TDD UL/DL configurations is associated with particular spatial information; and
perform communication activity with the at least one UE based on the plurality of UE-specific TDD UL/DL configurations, the communication activity comprising:
transmission in a first set of symbols of a slot, where at least one symbol of the first set of symbols of the slot overlaps with an uplink symbol indicated by the cell-specific TDD UL/DL configuration; or
reception in a second set of symbols of the slot, where at least one symbol of the second set of symbols of the slot overlaps with a downlink symbol indicated by the cell-specific TDD UL/DL configuration.

14. The apparatus of claim 13, wherein the processor is further configured to cause the apparatus to:
send, to a neighboring RAN node, a reference TDD UL/DL configuration for the first cell; and
send, to the neighboring RAN node, override information comprising a set of parameters indicating whether a respective symbol of the reference TDD UL/DL configuration is permitted to be overridden,
wherein the plurality of UE-specific TDD UL/DL configurations is generated based on the override information.

15. The apparatus of claim 14, wherein the override information is sent to multiple neighboring RAN nodes in a vicinity of the apparatus.
